(19) United States
(12) Patent Application Publication
(10) Pub. No.: US 2016/0258609 A1
(43) Pub. Date: Sep. 8, 2016

(54) LED LIGHTING APPARATUS

(71) Applicant: ROHM CO., LTD., Kyoto-shi (JP)

(72) Inventors: Yoshifumi FUJIMOTO, Kyoto-shi (JP); Hirotaka SHIMIZU, Kyoto-shi (JP); Hideharu OSAWA, Kyoto-shi (JP); Hiroki YONEDA, Kyoto-shi (JP)

(21) Appl. No.: 15/052,374

(22) Filed: Feb. 24, 2016

(30) Foreign Application Priority Data
Mar. 2, 2015 (JP) 2015-040414
Apr. 24, 2015 (JP) 2015-089556
Feb. 4, 2016 (JP) 2016-019602

(51) Int. Cl. F21V 23/04; F21V 23/02; G01S 13/04; F21V 29/74; H05B 33/08; G01S 13/86; F21V 3/04; F21V 29/503

(52) U.S. Cl. CPC F21V 23/0471; F21V 3/049; F21V 23/02; F21V 29/503; F21V 29/74; H05B 33/0854; G01S 13/86; G01S 13/04; F21Y 2101/02

(57) ABSTRACT

An LED lighting apparatus includes an LED light-emitting unit, a radar detector, a controller, and a translucent cover. The LED light-emitting unit has a plurality of LED chips. The radar detector transmits radio waves, receives radio waves reflected by an object, and detects a movement of the object based on a change in a wavelength of the received radio waves. The controller controls light emission of the LED light-emitting unit based on a result of the detection by the radar detector. The translucent cover covers the LED light-emitting unit in a main emission direction in which a center of the light emitted from the LED light-emitting unit travels, and allows light from the LED light-emitting unit and the radio waves from the radar detector to pass through. The radar detector is surrounded by the LED light-emitting unit in the main emission direction.

### BACKGROUND OF THE INVENTION

1. Field of the Invention

The present invention relates to an LED lighting apparatus.

2. Description of the Related Art

Japanese Patent Application Publication No. 2013-171650 discloses a lighting fixture that is to be attached to the ceiling or wall of a house, and that uses an LED chip as a light source. Such a lighting fixture includes an LED chip, a translucent cover that allows the light from the LED chip to pass through, and a case for holding the LED chip. The use of an LED chip as a light source allows for a reduction in power consumption, and for the extension of a replacement cycle.

However, even when an LED chip is used in an attempt to reduce power consumption, it is still essential that the light be turned on and off as necessary. It is cumbersome to perform such an on/off operation frequently. On the other hand, failing to perform such an operation will cause the power saving attempt to be less effective.

### SUMMARY OF THE INVENTION

The present invention has been proposed under the above circumstances, and an object thereof is to provide an LED lighting apparatus that can reduce power consumption without cumbersome operations.

According to a first aspect of the present invention, an LED lighting apparatus includes: an LED light-emitting unit having a plurality of LED chips; and a radar detector configured to detect the movement of an object by Doppler effect, i.e., based on a process of: transmission of radio waves, and reception of the radio waves reflected by the object, where the received radio waves have undergone a change in wavelength due to the movement of the object. The light emission of the LED light-emitting unit is controlled based on a result of the detection by the radar detector. The LED lighting apparatus further includes a translucent cover that covers the LED light-emitting unit in a main emission direction and allows light from the LED light-emitting unit and the radio waves from the radar detector to pass through, where the main emission direction is a direction in which a center of the light emitted from the LED light-emitting unit travels. The radar detector is surrounded by the LED light-emitting unit in the main emission direction.

Preferably, the translucent cover allows the light from the LED light-emitting unit to diffuse when the light passes through the translucent cover.

Preferably, the translucent cover is made of one of resin or glass.

Preferably, the LED lighting apparatus further includes a radar switching unit having the radar detection unit and a switch that is switched on and off based on a result of the detection by the radar detector.

Preferably, the LED lighting apparatus further includes a power unit configured to supply electric power to the LED light-emitting unit.

Preferably, the radar switching unit is electrically interposed between the power unit and the LED light-emitting unit.

Preferably, the LED light-emitting unit has an LED substrate that supports the plurality of LED chips.

Preferably, the LED substrate is annular in the main emission direction.

Preferably, the LED light-emitting unit includes a plurality of LED modules that have the LED chips, translucent resin that covers the LED chips, and mount terminals.

Preferably, the radar switching unit has a sensor substrate on which the radar detector is mounted, and a main substrate on which the switch is mounted.

Preferably, the sensor substrate is arranged more forward than the main substrate in the main emission direction.

Preferably, the main substrate and the sensor substrate overlap with each other in the main emission direction.

Preferably, the sensor substrate is positioned more forward than the LED substrate in the main emission direction.

Preferably, the sensor substrate is arranged in a position that avoids a light distribution angle that is a direction in which light of half a forward luminous intensity of each of the LED chips is emitted.

Preferably, the main substrate is positioned more backward than the LED substrate in the main emission direction.

Preferably, the sensor substrate and the LED substrate are integrated into a single substrate.

Preferably, the LED lighting apparatus further includes: a case that supports the LED light-emitting unit, the translucent cover, and the power unit; and a base fixed to the case and attachable to a feeding unit.

Preferably, attachment and detachment between the base and the feeding unit include a rotation of the base relative to the feeding unit.

Preferably, the base includes a pair of pins that are spaced apart from each other in a radial direction that is perpendicular to the main emission direction.

Preferably, the radar detector is sandwiched between the pair of pins in the main emission direction.

Preferably, the radar switching unit is sandwiched between the pair of pins in the main emission direction.

Preferably, the LED substrate overlaps the pair of pins in the main emission direction.

Preferably, the base includes a projection, and the projection is arranged between the pair of pins and protrudes backward in the main emission direction.

Preferably, the protrusion houses the power unit.

Preferably, the power unit has a portion positioned more backward than the pair of pins in the main emission direction.

Preferably, the LED lighting apparatus further includes a case having a bottomed tubular shape, having an opening, and supporting the LED light-emitting unit, the translucent cover, and the power unit. The translucent cover covers the opening.

Preferably, the case is made of metal.

Preferably, the LED lighting apparatus further includes an LED unit having the LED light-emitting unit, the power unit, and the radar switching unit.

Preferably, the LED unit includes a heat dissipater to which the LED light-emitting unit is attached.

Preferably, the heat dissipater has a top plate portion to which the LED light-emitting unit is attached, and a tubular portion that extends from the top plate portion in a direction opposite to a side to which the LED light-emitting unit is attached.

Preferably, the tubular portion has an outer surface on which a plurality of fins are provided.

Preferably, the power unit is housed in the tubular portion of the heat dissipater.

Preferably, the LED unit has an inner cover that is attached to the heat dissipater and allows the light from the LED light-emitting unit to pass through.

Preferably, the inner cover allows the light from the LED light-emitting unit to diffuse when the light passes through the inner cover.

Preferably, the inner cover is made of one of resin or glass.

According to a second aspect of the present invention, an LED lighting apparatus includes: an LED light-emitting unit having at least one LED chip; and a radar detector configured to detect a movement of an object based on transmission of radio waves, reception of radio waves reflected by the object, and Doppler effect of the received radio waves that is a change in a wavelength of the received radio waves due to the movement of the object. A light emission of the LED light-emitting unit is controlled based on a result of the detection of the radar detector. The LED lighting apparatus further includes a case that has a bottomed tubular shape and that has an opening; and a translucent cover that covers the opening of the case and allows the light from the LED light-emitting unit and the radio waves from the radar detector to pass through. The radar detector is housed in the case at a position deeper than the LED light-emitting unit in a depth direction of the case.

Preferably, the translucent cover allows the light from the LED light-emitting unit to diffuse when the light passes through the translucent cover.

Preferably, the translucent cover is made of one of resin or glass.

Preferably, the case is made of metal.

Preferably, the translucent cover has an inner circumferential surface that stands erect from the opening of the case in the opening direction of the opening.

Preferably, the LED lighting apparatus further includes a radar switching unit having the radar detection unit and a switch that is switched on and off based on a result of the detection by the radar detector.

Preferably, the LED lighting apparatus further includes a power unit configured to supply electric power to the LED light-emitting unit.

Preferably, the radar switching unit is electrically interposed between the power unit and the LED light-emitting unit.

Preferably, the LED lighting apparatus further includes an LED unit having the LED light-emitting unit and the power unit.

Preferably, the radar switching unit is arranged in an exterior of the LED unit.

Preferably, the LED lighting apparatus further includes a first cable connecting the power unit and the radar switching unit.

Preferably, the LED lighting apparatus further includes a second cable connecting the radar switching unit and the LED light-emitting unit.

Preferably, the LED unit includes a heat dissipater to which the LED light-emitting unit is attached.

Preferably, the heat dissipater has a top plate portion to which the LED light-emitting unit is attached, and a tubular portion that extends from the top plate portion in a direction opposite to a side to which the LED light-emitting unit is attached.

Preferably, the tubular portion has an outer surface on which a plurality of fins are provided.

Preferably, the power unit is housed in the tubular portion of the heat dissipater.

Preferably, the LED unit has an inner cover that is attached to the heat dissipater and allows the light from the LED light-emitting unit to pass through.

Preferably, the inner cover allows the light from the LED light-emitting unit to diffuse when the light passes through the inner cover.

Preferably, the inner cover is made of one of resin or glass.

Preferably, the inner cover has a light-incident flat surface that directly faces the LED light-emitting unit, and that receives the light from the LED light-emitting unit.

Preferably, the inner cover has a light-emitting curved surface that is arranged opposite to the light-incident flat surface, and that bulges outward.

Preferably, the inner cover has a recessed surface that is recessed from the light-emitting curved surface.

Preferably, the recessed surface is cone-shaped.

Preferably, the recessed surface overlaps the LED light-emitting unit in plan view.

Preferably, a center of the recessed surface in plan view coincides with a center of the LED light-emitting unit in plan view.

Preferably, the light-incident flat surface is rough.

Preferably, the light-emitting curved surface is rough.

Preferably, the recessed surface is smooth.

Preferably, the at least one LED chip comprises a plurality of LED chips, and the LED light-emitting unit has the plurality of LED chips and an LED substrate on which the LED chips are mounted.

Preferably, the LED light-emitting unit has a dam. The dam is mounted on the LED substrate and has an annular shape that surrounds the plurality of LED chips, and protrudes from a surface of the LED substrate.

Preferably, the dam is made of silicone resin.

Preferably, the LED light-emitting unit has sealing resin that fills an area surrounded by the dam and covers the plurality of LED chips.

Preferably, the sealing resin contains fluorescent substances that emit light at different wavelengths as a result of excitation by light from the plurality of LED chips.

According to the present invention, the radar detector is used to determine whether or not a user or the like is present, and the light emission of the LED light-emitting unit is controlled based on a result of the determination. This makes it possible, for example, to mitigate the task of the user turning on the LED lighting apparatus. Furthermore, wasteful illumination of unoccupied space can be prevented. Accordingly, it is possible to save power without cumbersome operations.

Other features and advantages of the present invention will become apparent from the detailed description given below with reference to the accompanying drawings.

### BRIEF DESCRIPTION OF THE DRAWINGS

FIG. 1 is a perspective view showing an LED lighting apparatus according to a first embodiment of the present invention;

FIG. 2 is a plan view showing the LED lighting apparatus in FIG. 1;

FIG. 3 is a front view showing the LED lighting apparatus in FIG. 1;

FIG. 4 is a bottom view showing the LED lighting apparatus in FIG. 1;

FIG. 5 is a cross-sectional view along the line V-V in FIG. 2;

FIG. 6 is a plan view showing a main part of the LED lighting apparatus in FIG. 1;

FIG. 7 is a cross-sectional view showing an LED module used in the LED lighting apparatus in FIG. 1;

FIG. 8 is a plan view showing a radar switching unit used in the LED lighting apparatus in FIG. 1;

FIG. 9 is a cross-sectional view along the line IX-IX in FIG. 8;

FIG. 10 is a perspective view showing a use state of the LED lighting apparatus in FIG. 1;

FIG. 11 is a system configuration diagram showing the LED lighting apparatus in FIG. 1;

FIG. 12 is a flowchart showing an operation of the LED lighting apparatus in FIG. 1;

FIG. 13 is a system configuration diagram showing a variation of the LED lighting apparatus according to the first embodiment of the present invention;

FIG. 14 is a cross-sectional view showing another variation of the LED lighting apparatus according to the first embodiment of the present invention;

FIG. 15 is a cross-sectional view showing another variation of the LED lighting apparatus according to the first embodiment of the present invention;

FIG. 16 is a plan view showing a main part of the LED lighting apparatus in FIG. 15;

FIG. 17 is a cross-sectional view showing another variation of the LED lighting apparatus according to the first embodiment of the present invention;

FIG. 18 is a cross-sectional view showing another variation of the LED lighting apparatus according to the first embodiment of the present invention;

FIG. 19 is a plan view showing an LED lighting apparatus according to a second embodiment of the present invention;

FIG. 20 is a cross-sectional view along the line XX-XX in FIG. 19;

FIG. 21 is a perspective view showing an LED unit used in the LED lighting apparatus in FIG. 19;

FIG. 22 is a perspective view showing the LED unit used in the LED lighting apparatus in FIG. 19;

FIG. 23 is a cross-sectional view along the line XXIII-XXIII in FIG. 21;

FIG. 24 is a system configuration diagram showing an LED lighting apparatus according to a third embodiment of the present invention;

FIG. 25 is a flowchart showing an example of an operation of the LED lighting apparatus in FIG. 24;

FIG. 26 is a flowchart showing another example of an operation of the LED lighting apparatus in FIG. 24;

FIG. 27 is a plan view showing an LED lighting apparatus according to a fourth embodiment of the present invention;

FIG. 28 is a cross-sectional view along the line XXVIII-XXVIII in FIG. 27;

FIG. 29 is a perspective view showing an LED unit used in the LED lighting apparatus in FIG. 27;

FIG. 30 is a perspective view showing the LED unit used in the LED lighting apparatus in FIG. 27;

FIG. 31 is a plan view showing the LED unit used in the LED lighting apparatus in FIG. 27;

FIG. 32 is a front view showing the LED unit used in the LED lighting apparatus in FIG. 27;

FIG. 33 is a side view showing the LED unit used in the LED lighting apparatus in FIG. 27;

FIG. 34 is a cross-sectional view along the line XXXIV-XXXIV in FIG. 33;

FIG. 35 is a cross-sectional view showing an LED light-emitting unit used in the LED lighting apparatus in FIG. 27;

FIG. 36 is a plan view showing a radar switching unit used in the LED lighting apparatus in FIG. 27;

FIG. 37 is a cross-sectional view along the line XXXVII-XXXVII in FIG. 36;

FIG. 38 is a perspective view showing a use state of the LED lighting apparatus in FIG. 27;

FIG. 39 is a system configuration diagram showing the LED lighting apparatus in FIG. 27;

FIG. 40 is a flowchart showing an operation of the LED lighting apparatus in FIG. 27; and

FIG. 41 is a block diagram showing an LED lighting apparatus according to a fifth embodiment of the present invention.

### DESCRIPTION OF THE PREFERRED EMBODIMENTS

Hereinafter, preferred embodiments of the present invention will be described in detail with reference to the drawings.

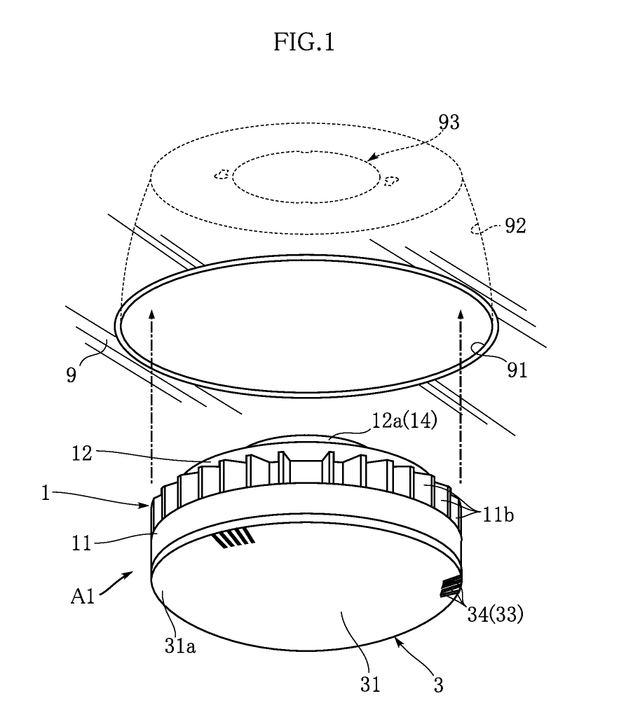

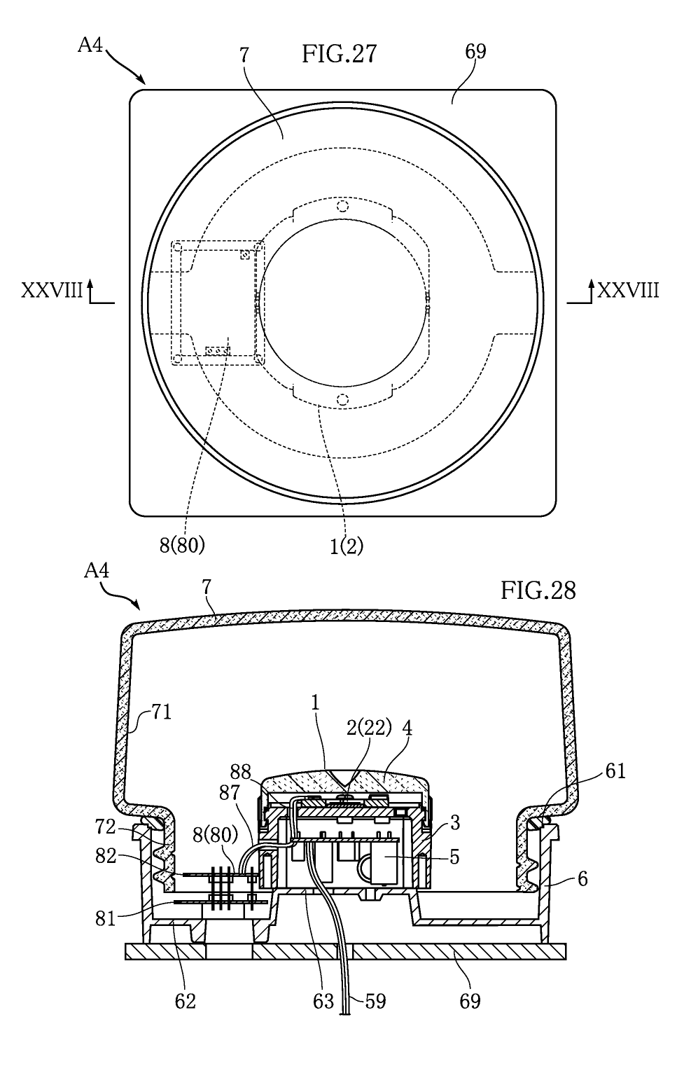

The reference signs in FIGS. 1 to 26, as well as the reference signs and terms used for LED lighting apparatuses A1 to A3 in first to third embodiments described below with reference to FIGS. 1 to 26, are only in effect within the said embodiments. These reference signs and terms are independent from the reference signs in FIGS. 27 to 41 and the reference signs and terms used for LED lighting apparatuses A4 and A5 in fourth and fifth embodiments described with reference to FIGS. 27 to 41.

FIGS. 1 to 6 show an LED lighting apparatus according to a first embodiment of the present invention. An LED lighting apparatus A1 includes a case 1, an LED light-emitting unit 2, a translucent cover 3, a power unit 5, and a radar switching unit 8. As shown in FIG. 1, the LED lighting apparatus A1 serves as a downlight by being attached to a feeding unit 93 arranged at the depth of a fitting hole 91 provided in a ceiling 9. In the present embodiment, the LED lighting apparatus A1 has a substantially columnar shape with its axial length being relatively short.

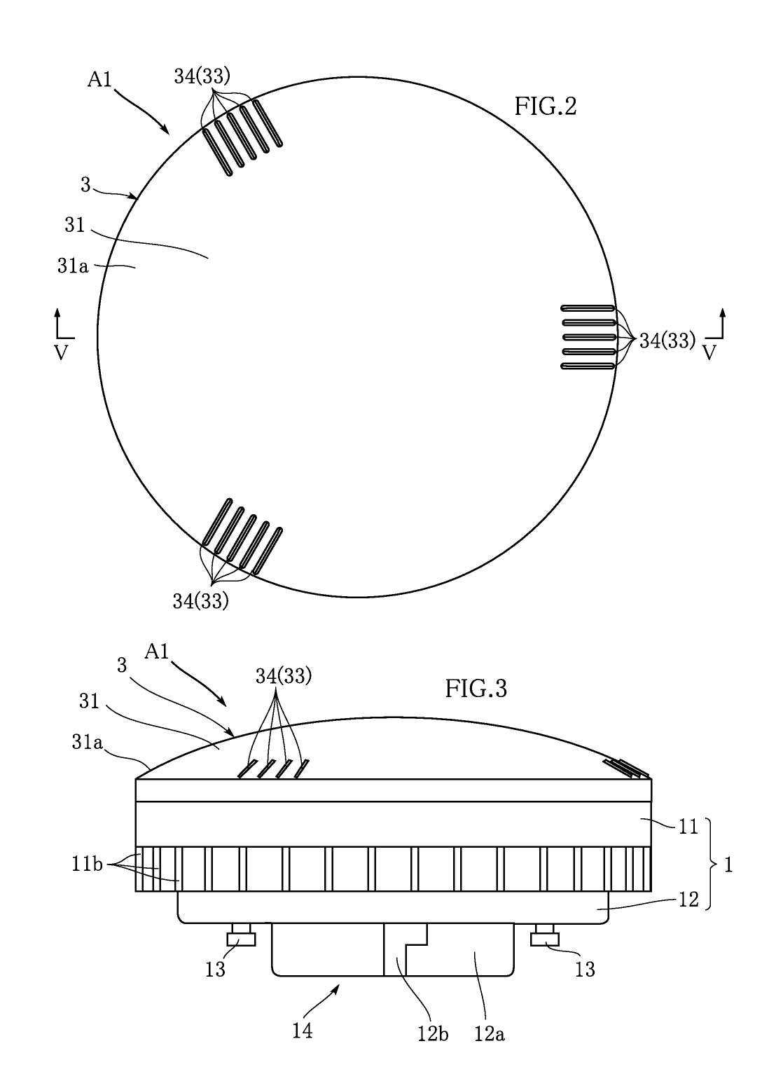

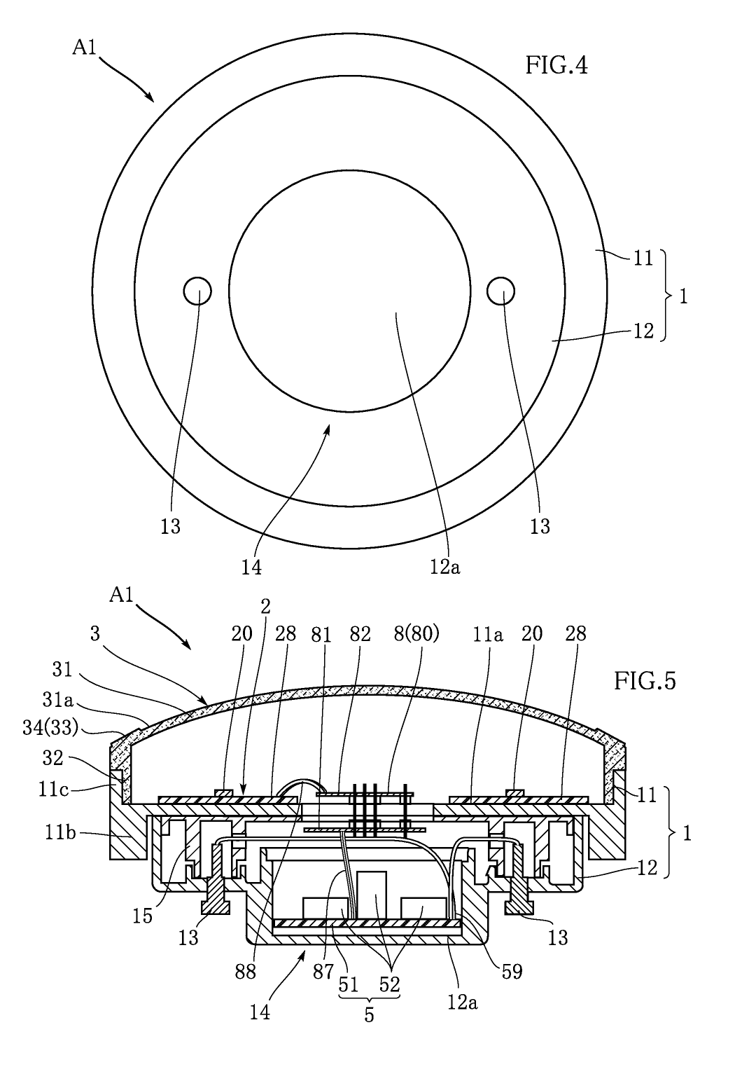

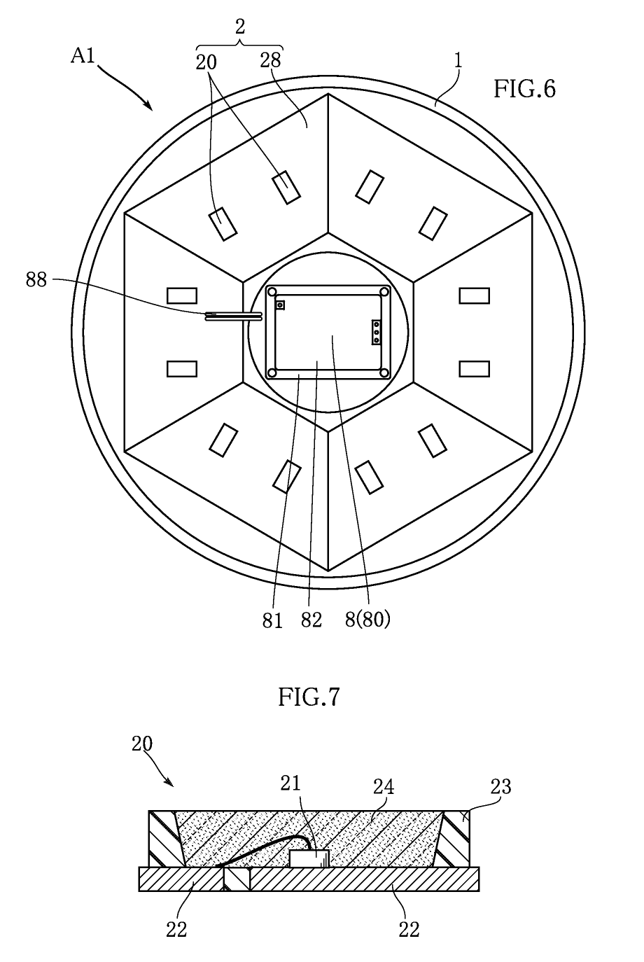

FIG. 1 is a perspective view showing the LED lighting apparatus A1. FIG. 2 is a plan view showing the LED lighting apparatus A1. FIG. 3 is a front view showing the LED lighting apparatus A1. FIG. 4 is a bottom view showing the LED lighting apparatus A1. FIG. 5 is a cross-sectional view along the line V-V in FIG. 2. FIG. 6 is a plan view showing a main part of the LED lighting apparatus A1.

The case 1 houses or holds the LED light-emitting unit 2, the translucent cover 3, and the power unit 5. In the present embodiment, the case 1 is composed of a heat dissipation member 11, an insulation member 12, and an intermediate member 15. In the present embodiment, the case 1 is circular in plan view.

The heat dissipation member 11 is a member intended to dissipate heat from the LED light-emitting unit 2, and is made of metal such as aluminum. The heat dissipation member 11 has a mounting surface 11a, a plurality of fins 11b, and an engagement part 11c. The mounting surface 11a faces forward in a main emission direction, which is a direction in which the center of the light emitted from the LED light-emitting unit 2 travels (upward in FIG. 5). The mounting surface 11a is a substantially circular flat surface. The plurality of fins 11b facilitate dissipation of heat from the LED light-emitting unit 2, and are provided along the entire periphery of the heat dissipation member 11. The fins 11b are parallel to the axial direction (i.e., main emission direction) and radial direction of the LED lighting apparatus A1. The engagement part 11c has an annular shape that surrounds the mounting surface 11a. The engagement part 11c is used to attach the translucent cover 3.

The insulation member 12 is attached to a rear side of the heat dissipation member 11 in the main emission direction, which is located opposite to a front side of the heat dissipation member 11 in the main emission direction. In the present embodiment, the insulation member 12 is circular in plan view. The insulation member 12 is made of insulating material, and in the present embodiment, is made of polybutylene terephthalate (PBT) resin, for example. The insulation member 12 has a protrusion 12a. The protrusion 12a is a columnar portion protruding backward in the main emission direction. As shown in FIG. 3, the protrusion 12a has a groove 12b. The groove 12b has a first portion extending in the main emission direction, and a second portion continuous from the first portion and extending in a circumferential direction of the protrusion 12a. The insulation member 12 is provided with a pair of pins 13. The pair of pins 13 are positioned opposite to each other in the radial direction with the protrusion 12a therebetween, and protrudes backward in the main emission direction. The protrusion 12a and the pair of pins 13 constitute a base 14. As described below, the base 14 is used to attach the LED lighting apparatus A1 to the feeding unit 93 provided in the ceiling 9, for example, and is of GX53 type in IEC standards, for example. In this case, the distance between the centers of the pair of pins 13 is 53 mm.

The intermediate member 15 is provided between the heat dissipation member 11 and the insulation member 12. The intermediate member 15 is made of insulating material, and in the present embodiment, is made of polybutylene terephthalate (PBT) resin, for example. The intermediate member 15 fixedly holds the pair of pins 13 and the power unit 5, and holds wiring lines or the like that connect the pair of pins 13, the LED light-emitting unit 2, and the power unit 5.

The LED light-emitting unit 2 serves as a light source of the LED lighting apparatus A1. The LED light-emitting unit 2 includes an LED substrate 28 and a plurality of LED modules 20.

As shown in FIG. 6, the LED substrate 28 is annular in plan view (in the main emission direction). In the present embodiment, the LED substrate 28 is composed of a plurality of small pieces that have a hexagonal ring shape as a whole in plan view. The LED substrate 28 has the plurality of LED modules 20 mounted thereon. For example, the LED substrate 28 may have a base made of glass epoxy resin and a wiring pattern formed on the base.

The plurality of LED modules 20 serve as a light source of the LED lighting apparatus A1. FIG. 7 is an enlarged cross-sectional view showing one of the LED modules 20 of the present embodiment. The LED module 20 includes an LED chip 21, a pair of leads 22, a case 23, and a translucent resin 24.

The LED chip 21 may be a GaN-based semiconductor and may emit blue light. The translucent resin 24 covers the LED chip 21, and is made of a transparent resin including a fluorescent material, for example. The fluorescent material emits yellow light as a result of excitation by the blue light from the LED chip 21. The type and concentration of the fluorescent material are selected such that when the blue light from the LED chip 21 is mixed with the yellow light from the fluorescent material, the light color becomes white or near-white such as daylight white.

The pair of leads 22 support the LED chip 21, serve as a conduction path to the LED chip 21, and are made of copper (Cu) alloy, for example. The lower surfaces of the pair of leads 22 constitute mount terminals in the present invention. The LED module 20 is mounted on a surface of the LED substrate 28.

The case 23 is made of white resin, for example, and is in the shape of a frame surrounding the LED chip 21. An inner surface of the case 23 serves as a reflector that reflects and emits the light from the LED chip 21.

As can be understood from FIG. 2, the LED substrate 28 of the LED light-emitting unit 2 overlaps with the pair of pins 13 in the main emission direction (in plan view).

The translucent cover 3 is attached to the case 1 to be located forward in the main emission direction. The translucent cover 3 allows the light from the LED light-emitting unit 2 to pass through. In the present embodiment, the translucent cover 3 allows the light from the LED light-emitting unit 2 to pass through and diffuse. Examples of the material of the translucent cover 3 include translucent resin or glass in which diffusion material is mixed. With such a structure, the translucent cover 3 has an opaque white color.

In the present embodiment, the translucent cover 3 is circular in plan view, and has a bulge 31, an engagement part 32, and a high-friction part 33. The bulge 31 is a portion that bulges forward in the main emission direction. In the present embodiment, the bulge 31 bulges to form a dome shape as a whole. The bulge 31 has a sloping surface 31a. The sloping surface 31a is an outer peripheral surface of the bulge 31, and slopes relative to the radial direction and circumferential direction of the translucent cover 3, i.e., a direction in which the mounting surface 11a of the heat dissipation member 11 of the case 1 spreads. The engagement part 32 is provided at a peripheral edge of the translucent cover 3, and engages with the engagement part 11c of the heat dissipation member 11 of the case 1 so that the translucent cover 3 is attached to the case 1.

The high-friction part 33 is intended to demonstrate a higher friction force than other parts of the translucent cover 3 when touched by a human's finger. The “friction force”, as mentioned herein, is a broad concept that includes not only a pure friction force that acts vertically to the surface of an object, but also a force that may be generated by a geometric feature (such as roughness) of another object. The high-friction part 33 is provided on the sloping surface 31a, and in the present embodiment, around the entire circumference of the translucent cover 3.

As shown in FIGS. 1 to 3, in the present embodiment, the high-friction part 33 consists of a plurality of ribs 34. The ribs 34 extend in the radial direction in plan view and stand erect from the sloping surface 31a in the main emission direction. In the present embodiment, the high-friction part 33 is divided into a plurality of groups that are spaced apart in the circumferential direction of the translucent cover 3. In other words, the plurality of ribs 34 are divided into three groups that are spaced apart from each other in the circumferential direction of the translucent cover 3. These groups are spaced apart from each other, for example, at an angle of 120° in the circumferential direction.

As shown in FIG. 1, the ceiling 9 is provided with the fitting hole 91 inside which a reflector 92 is provided. Also, the feeding unit 93 is provided at the depth of the fitting hole 91. The feeding unit 93 is configured such that a base of GX53 type in IEC standards can be attached thereto. The LED lighting apparatus A1 is inserted into the fitting hole 91 from below to be positioned at the depth of the fitting hole 91.

Next, the LED lighting apparatus A1 is rotated relative to the feeding unit 93. In this way, the pair of pins 13 at the base 14 engage with the feeding unit 93. Also, the groove 12b in the protrusion 12a of the insulation member 12 engages with the feeding unit 93. In the relative rotation, the LED lighting apparatus A1 that is circular in plan view is rotated about an axis extending in the axial direction of the LED lighting apparatus A1. At this time, the user rotates the LED lighting apparatus A1 with his/her fingers on the high-friction part 33 of the translucent cover 3. When attached to the feeding unit 93, the LED lighting apparatus A1 can receive power supplied by the feeding unit 93 and is surrounded by the reflector 92. In this way, a so-called downlight is configured. When supplied with power via a switch (not shown), the LED light-emitting unit 2 in the LED lighting apparatus A1 lights up. The light from the LED light-emitting unit 2 passes through the translucent cover 3, and a part of the light directly illuminates a floor surface, while another part of the light is reflected by the reflector 92 and thereby illuminates a floor surface and a wall surface.

When detaching the LED lighting apparatus A1 from the ceiling 9, the user keeps his/her fingers on the high-friction part 33 of the translucent cover 3 and, in this state, rotates the LED lighting apparatus A1 in a direction opposite to the direction in which the LED lighting apparatus A1 is rotated to be attached. As a result, the base 14 is disengaged from the feeding unit 93, and the LED lighting apparatus A1 is removed from the ceiling 9.

The power unit 5 converts, for example, commercial AC power of 100 V to DC power suitable for lighting the plurality of LED chips 21 of the LED light-emitting unit 2. The power unit 5 is housed in the protrusion 12a of the base 14.

According to the present embodiment, the power unit 5 is composed of a power substrate 51 and a plurality of electronic components 52.

The power substrate 51 serves as a base for the power unit 5, and supports the plurality of electronic components 52. In addition, the power substrate 51 has a conduction path that electrically connects the plurality of electronic components 52 as necessary. In the present embodiment, as shown in FIG. 5, the power substrate 51 is arranged at a lower side of the protrusion 12a in the figure (i.e., backward in the main emission direction).

The plurality of electronic components 52 constitute a power circuit that realizes the function of the power unit 5. Examples of the plurality of electronic components 52 include transformers, capacitors, resistors, and diodes; however, the types and specifications of the plurality of electronic components 52 are not limited to such.

The power unit 5 is connected to cables 59. The cables 59 lead power received from an external source to the power unit 5, and are connected to the power unit 5 and the pins 13 of the case 1.

As shown in FIG. 5, according to the present embodiment, the protrusion 12a of the base 14 protrudes more backward than the pair of pins 13 in the main emission direction. Also, the power unit 5 has a portion positioned more backward than the pair of pins 13 in the main emission direction.

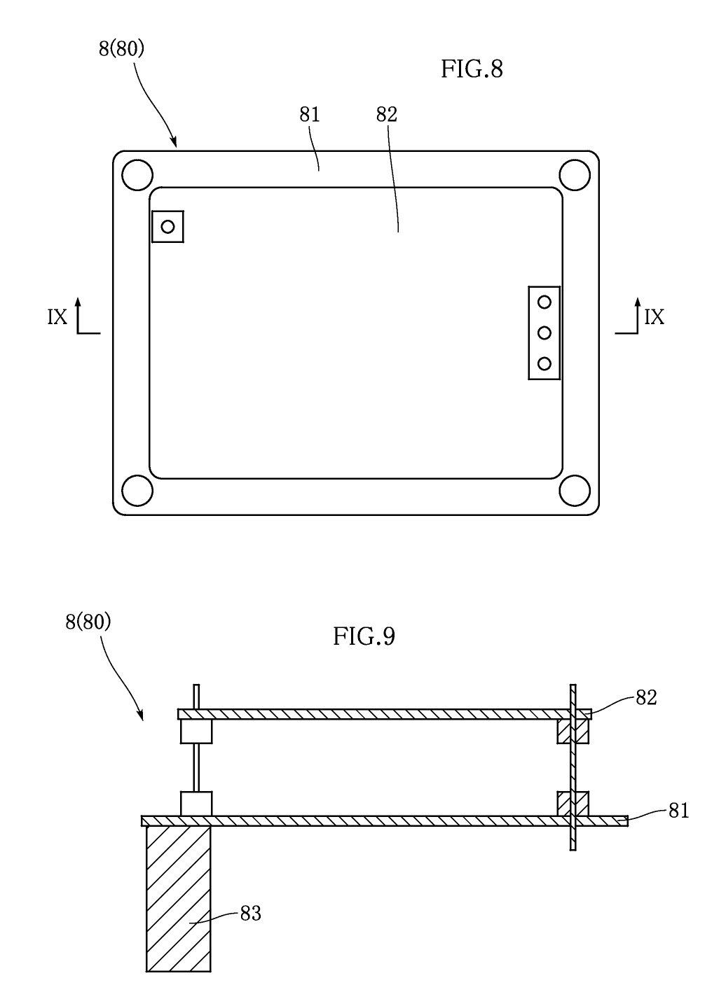

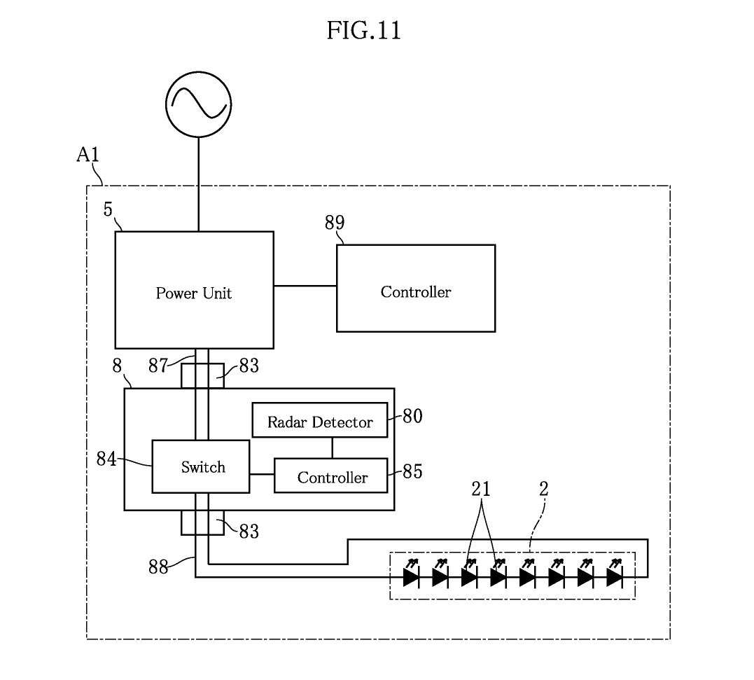

FIG. 8 is a plan view showing the radar switching unit 8. FIG. 9 is a cross-sectional view along the line IX-IX in FIG. 8. FIG. 11 is a system configuration diagram showing the LED lighting apparatus A1.

The radar switching unit 8 includes a radar detector 80, a main substrate 81, a sensor substrate 82, a connector 83, a switch 84, and a controller 85.

The radar detector 80 detects the movement of an object based on the transmission of radio waves, reception of the radio waves reflected by the object, and the Doppler effect of the received radio waves that is a change in a wavelength of the received radio waves due to the movement of the object. In the present embodiment, a transmission device and a reception device for the radar detector 80 are mounted on the sensor substrate 82.

The main substrate 81 is, for example, a substrate on which the switch 84 and the controller 85 are mounted. The main substrate 81 is a wiring substrate having a base member that is made of glass epoxy resin, for example.

The sensor substrate 82 is, for example, a substrate on which the transmission device and reception device of the radar detector 80 are mounted. The sensor substrate 82 is a wiring substrate having a base member that is made of glass epoxy resin, for example.

The connector 83 connects the radar switching unit 8 to the LED light-emitting unit 2 and the power unit 5. In the present embodiment, the connector 83 is attached to the main substrate 81 and protrudes downward in the figure.

The switch 84 is arranged in a current path so as to turn on and off the current flowing in the current path. In the present embodiment, the switch 84 is mounted on the main substrate 81.

The controller 85 controls the radar switching unit 8 to perform necessary functions, and is typically an IC, for example. For example, the controller 85 receives a detection signal from the radar detector 80, and controls the switch 84 to turn on/off based on the detection signal.

As shown in FIG. 6, the radar switching unit 8 is surrounded by the LED light-emitting unit 2 as viewed in the main emission direction (i.e., in plan view). Also, as shown in FIG. 5, in the present embodiment, the sensor substrate 82 is positioned more forward than the LED substrate 28 of the LED light-emitting unit 2 in the main emission direction. The main substrate 81 is positioned more backward than the LED substrate 28 of the LED light-emitting unit 2 in the main emission direction. The main substrate 81 and the sensor substrate 82 overlap with each other in the main emission direction (i.e., in plan view). The radar switching unit 8 is positioned between the pair of pins 13 in the main emission direction (i.e., in plan view). That is, the main substrate 81 and the sensor substrate 82 are both positioned between the pair of pins 13 in the main emission direction (i.e., in plan view).

As shown in FIG. 11, the radar switching unit 8 is electrically interposed between the power unit 5 and the LED light-emitting unit 2. That is, the conduction path connecting the power unit 5 and the LED light-emitting unit 2 is switched between an open state and a blocked state by the switch 84 of the radar switching unit 8.

The LED lighting apparatus A1 includes a first cable 87 and a second cable 88. The first cable 87 connects the power unit 5 and the radar switching unit 8. The second cable 88 connects the radar switching unit 8 and the LED light-emitting unit 2. That is, the power supplied from the power unit 5 is input to the switch 84 of the radar switching unit 8 via the first cable 87. Subsequently, the power output from the switch 84 is lead from the radar switching unit 8 to the LED light-emitting unit 2 via the second cable 88.

The LED lighting apparatus A1 includes a controller 89. For example, the controller 89 transmits a command relating to the power supply state of the power unit 5. Note that the functions of the controller 89 may be incorporated into the power unit 5.

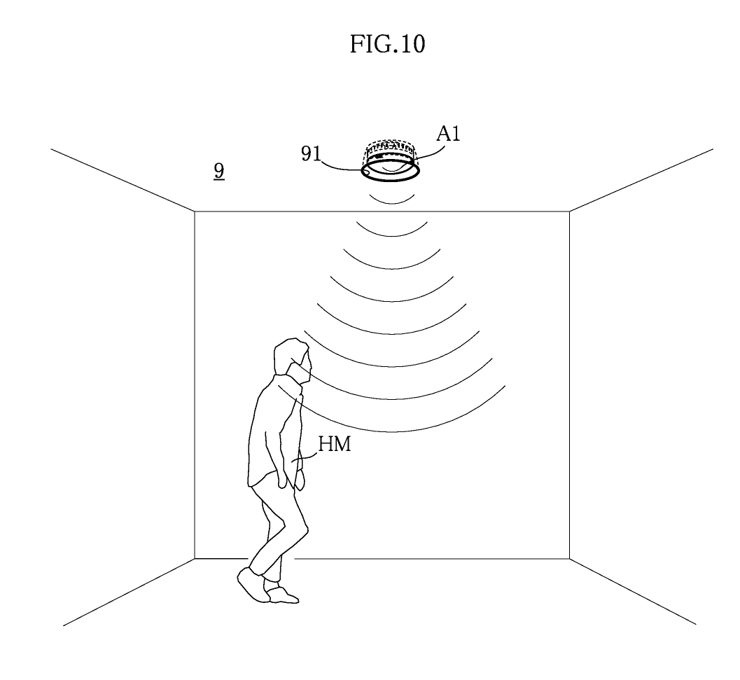

The following describes an operation of the LED lighting apparatus A1 with reference to FIGS. 10 to 12.

FIG. 10 shows one form of the environment in which the LED lighting apparatus A1 is used. In this figure, the LED lighting apparatus A1 is installed in a room. In the illustrated example, the LED lighting apparatus A1 is attached to the ceiling 9 in the procedure described above. The description below provides an example of the operation of the LED lighting apparatus A1 when a user HM walks into this room.

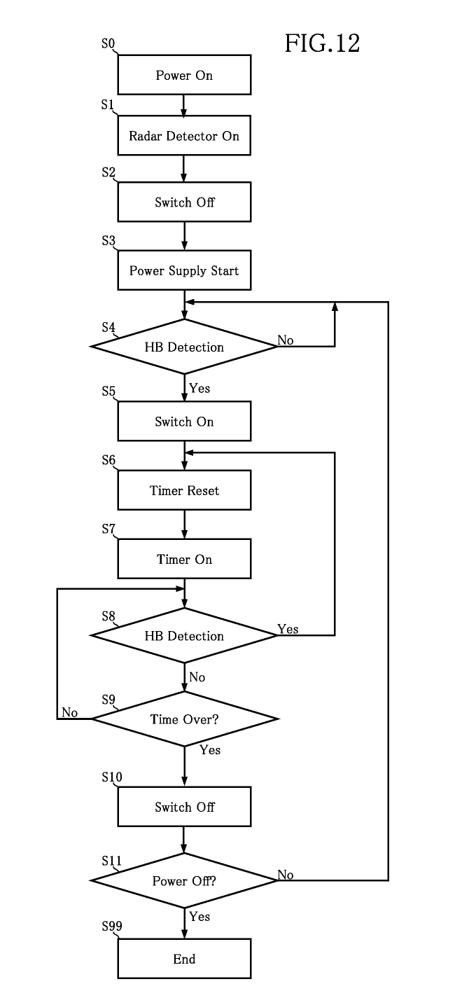

FIG. 12 is a flowchart showing the operation of the LED lighting apparatus A1. First, in step S0, the LED lighting apparatus A1 is powered on. In step S1, an initialization process is performed so that the radar detector 80 is placed in ON state and the transmission and reception of radio waves is started. In step S2, the switch 84 of the radar switching unit 8 is placed in OFF state by the controller 85. As a result, the LED light-emitting unit 2 is placed in a light-off state. In step S3, the power unit 5 starts to supply power to light the LED light-emitting unit 2.

Next, in step S4, a human body (HB) detection is performed. Note that the radar detector 80 of the radar switching unit 8 can detect an object other than a human body due to its principle. If the user HM is not in the room (step S4: No), the controller 85 maintains the switch 84 at OFF state and performs step S4 again.

If the user HM is detected in the room (step S4: Yes), the controller 85 switches the switch 84 to ON state, based on a detection signal from the radar detector 80. This allows the power from the power unit 5 to be supplied to the LED light-emitting unit 2 via the first cable 87, the switch 84, and the second cable 88. As a result, the LED light-emitting unit 2 lights up, and the room is illuminated by the LED lighting apparatus A1.

Next, in step S6, a timer in the controller 85 is reset, and in step S7, counting by the timer is started. If the user HM is not detected in step S8 (step S8: No), a determination is performed, in step S9, as to whether the count of the timer has reached a predetermined light-up expiry time. If the count has not reached the light-up expiry time (step S9: No), step S8 is repeated.

If the user HM is re-detected in step S8 (step S8: Yes), the controller 85 performs step S6 to reset the timer, and the counting by the timer in step S7 is restarted.

When the count reaches the light-up expiry time in step S9 (step S9: Yes), the controller 85 switches the switch 84 to OFF state in step S10. As a result, the power supply to the LED light-emitting unit 2 is cut off, causing the LED lighting apparatus A1 to be turned off.

If a power-off operation is not per formed in step S11 (step S11: No), steps from step S4 onward are performed in sequence. On the other hand, if a power-off operation is performed (step S11: Yes), all processes are ended and the power is turned off.

Next, advantages of the LED lighting apparatus A1 will be described.

According to the present embodiment, the radar detector 80 is used to determine whether or not the user HM or the like is present, and the light emission of the LED light-emitting unit 2 is controlled based on a result of the determination. This makes it possible to, for example, mitigate the task of the user HM turning on the LED lighting apparatus A1. Furthermore, it is possible to prevent wasteful illumination of unoccupied space. Accordingly, power can be saved without cumbersome operations.

Since the radar detector 80 is surrounded by the LED light-emitting unit 2, the radar detector 80 can be arranged right opposite to an area that is to be illuminated by the LED lighting apparatus A1. This can enhance the detection sensitivity of the radar detector 80.

The translucent cover 3 allows the radio waves from the radar detector 80 to pass through, as well as the light from the LED light-emitting unit 2. This prevents the radar detector 80 from being conspicuous from the exterior appearance of the LED lighting apparatus A1. In addition, light diffusion by the translucent cover 3 is preferable in preventing the radar detector 80 from appearing on the exterior appearance of the LED lighting apparatus A1.

As shown in FIG. 5, the sensor substrate 82 is positioned more forward than the LED substrate 28 of the LED light-emitting unit 2 in the main emission direction. This makes it possible to more reliably transmit and receive radio waves. In addition, the main substrate 81 is positioned more backward than the LED substrate 28 of the LED light-emitting unit 2 in the main emission direction. This prevents the entirety of the radar switching unit 8 from significantly protruding forward in the main emission direction.

The radar switching unit 8 includes the radar detector 80, and the switch 84 that is switched on and off based on a result of the detection by the radar detector 80. Also, the radar switching unit 8 is electrically interposed between the power unit 5 and the LED light-emitting unit 2. Accordingly, as long as the power unit 5 is ready to light the LED light-emitting unit 2 regardless of whether the user HM is present or not, the switch 84 of the radar switching unit 8 can solely determine whether to actually turn on the LED light-emitting unit 2 or not. This is advantageous in that, for example, the power unit 5 can be used as a common component between an LED lighting apparatus that does not include the radar detector 80 and the LED lighting apparatus A1.

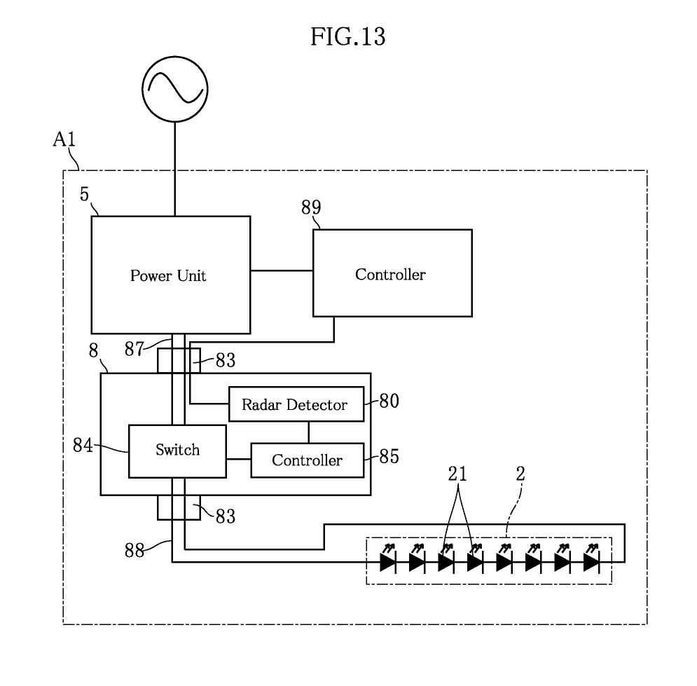

FIGS. 13 to 25 show variations and other embodiments of the present invention. Note that in these figures, elements that are the same as or similar to the elements in the above embodiment are provided with the same reference signs.

FIG. 13 is a system configuration diagram showing a variation of the LED lighting apparatus A1. In the present variation, a detection signal of the radar detector 80 of the radar switching unit 8 is transmitted not only to the controller 85 of the radar switching unit 8, but also to the controller 89 for the LED lighting apparatus A1 as a whole. The controller 89 controls the power supply from the power unit 5 according to state information. The state information is indicated by the detection signal from the radar detector 80, and includes data on whether an object such as the user HM is present or not. For example, suppose that the state information includes time and the brightness of the surroundings in addition to the data on whether an object is present or not. In this case, if it is daytime and the surroundings are bright enough, the controller 89 controls the LED light-emitting unit 2 so as not to light up even if the user HM is detected. Alternatively, if it is between the early evening and sunset and the surroundings are dark, the controller 89 controls the LED light-emitting unit 2 to light up with an appropriate luminance.

Such a variation can also save power without cumbersome operations.

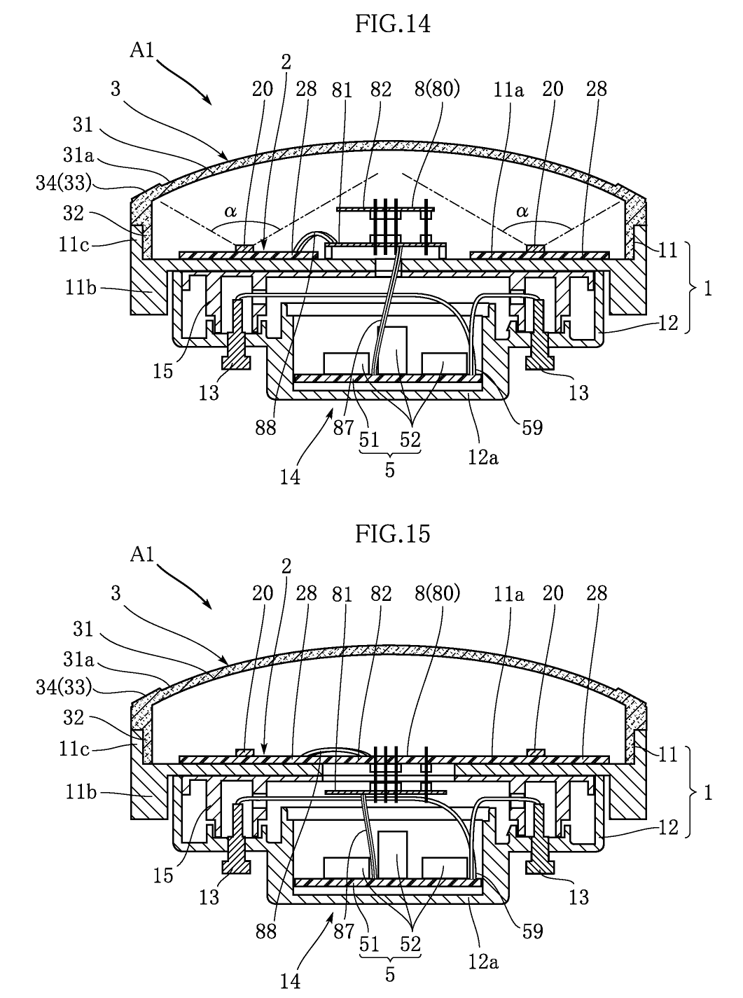

FIG. 14 shows another variation of the LED lighting apparatus A1. In the present variation, the main substrate 81 and the sensor substrate 82 are positioned more forward than the LED substrate 28 of the LED light-emitting unit 2 in the main emission direction. In such a variation, the sensor substrate 82 protrudes more forward from the LED substrate 28 in the main emission direction than the example shown in FIG. 5. In the present variation, the sensor substrate 82 is arranged in a position that avoids a light distribution angle α of each LED module 20 (lead 22). The light distribution angle α is a direction in which the light of half the forward luminous intensity of the LED module 20 (lead 22) is emitted. The distribution angle α is 110° to 130°, for example.

Such a variation can also save power without cumbersome operations. In addition, although the main substrate 81 and the sensor substrate 82 are positioned more forward than the LED substrate 28 in the main emission direction, the radar switching unit 8 is arranged in a position that avoids the light distribution angle α. In this way, the radar switching unit 8 is prevented from blocking the light from the LED light-emitting unit 2 (LED module 20). Because of this structure, the LED lighting apparatus A1 is suitable in achieving high luminance.

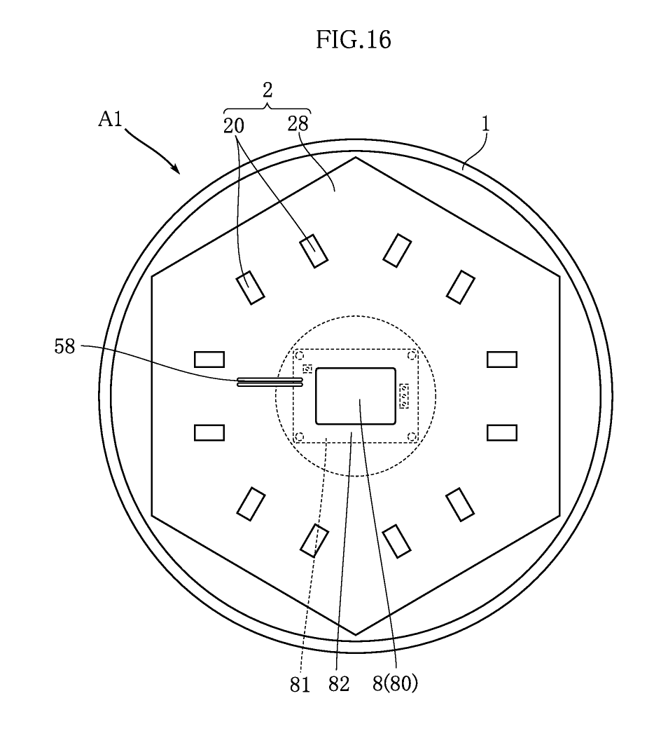

FIGS. 15 and 16 show another variation of the LED lighting apparatus A1. FIG. 15 is a cross-sectional view showing the LED lighting apparatus A1 according to the present variation, and FIG. 16 is a plan view showing a main part of the LED lighting apparatus A1 according to the present variation. In the present variation, the LED substrate 28 of the LED light-emitting unit 2 and the sensor substrate 82 of the radar switching unit 8 are integrated into a single substrate. In other words, for example, a peripheral part of a single substrate that is hexagonal in the main emission direction (in plan view) constitutes the LED substrate 28, and a central part of the single substrate constitutes the sensor substrate 82 of the radar switching unit 8. Accordingly, in the present variation, the LED substrate 28 and the sensor substrate 82 coincide in position in the main emission direction.

Such a variation can also save power without cumbersome operations. Also, the LED substrate 28 does not need to be an independent annular substrate. Since the LED substrate 28 and the sensor substrate 82 are integrated into a single substrate, cost can be reduced. Note that the examples shown in FIGS. 2, 14, and 15 are appropriately applicable to the following embodiments.

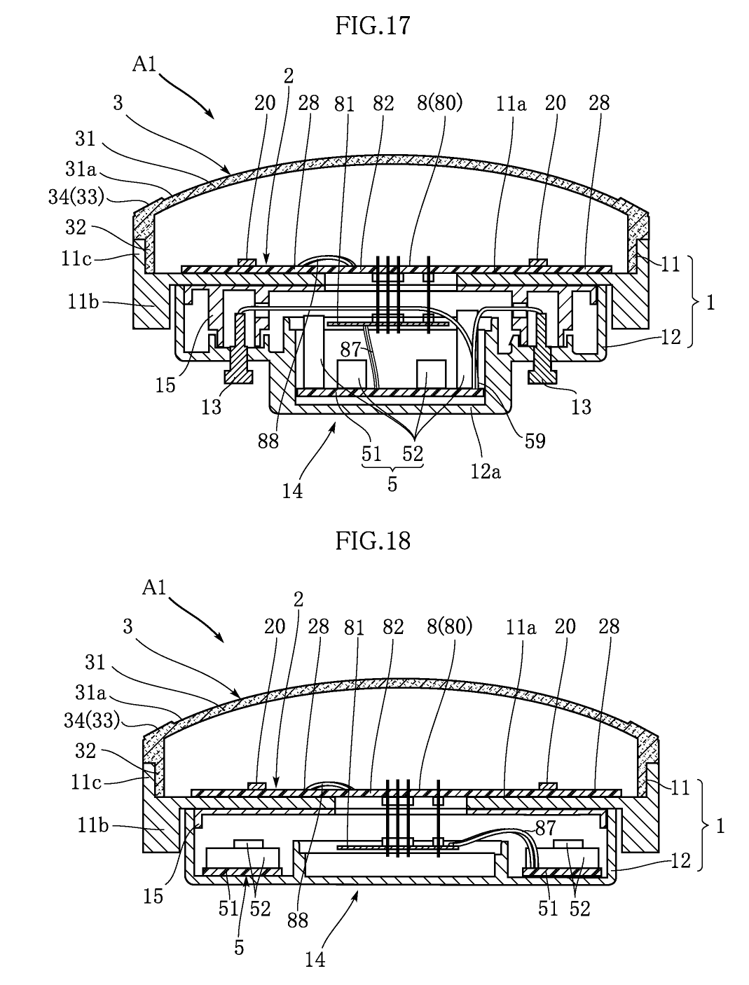

FIG. 17 shows another variation of the LED lighting apparatus A1. In the present variation, the plurality of electronic components 52 include relatively tall electronic components and relatively short electronic components. The relatively tall electronic components 52 are arranged more outward, and the relatively short electronic components are arranged more inward. Also, the radar switching unit 8 overlaps with some of the plurality of electronic components 52 in a thickness direction of the LED substrate 23.

Such a variation can also save power without cumbersome operations. Since the radar switching unit 8 overlaps with some of the plurality of electronic components 52 in the thickness direction of the LED substrate 28, interference between the power unit 5 and the radar switching unit 8 can be avoided. This is advantageous in making the LED lighting apparatus A1 thinner as a whole.

FIG. 18 shows another variation of the LED lighting apparatus A1. FIG. 18 is a cross-sectional view along a different line from the line V-V in FIG. 2, and shows a cross-section forming a 90 degree angle relative to the cross section in FIG. 5, for example. In the present variation, the power unit 5 is divided into multiple portions that sandwich the radar switching unit 8 from both sides in plan view. Also, among the plurality of electronic components 52, elongated electronic components having a longitudinal axis are arranged in an orientation in which the longitudinal axis is perpendicular to a thickness direction of the power substrate 51. Also, the power unit 5 does not overlap the radar switching unit 8 in plan view. Accordingly, in the present variation, the insulation member 12 does not have the protrusion 12a described in the above examples, and a portion of the insulation member 12 opposite to the LED light-emitting unit 2 is flat. Note that the insulation member 12 may have the protrusion 12a unlike the illustrated example. In this case, the protrusion 12a may house a part of the radar switching unit 8, or a constituent element other than the power unit 5 and the radar switching unit 8.

Such a variation can also save power without cumbersome operations. Also, since the portions of the power unit 5 sandwich the protrusion 12a from both sides, interference between the power unit 5 and the radar switching unit 8 can be avoided. This is advantageous in making the LED lighting apparatus A1 thinner as a whole. Furthermore, the plurality of electronic components 52 of the power unit 5 are spaced apart from each other at both sides. For example, two electronic components 52 each having a relatively large heat value can be arranged separately from each other, whereby a heat generation source can be dispersed.

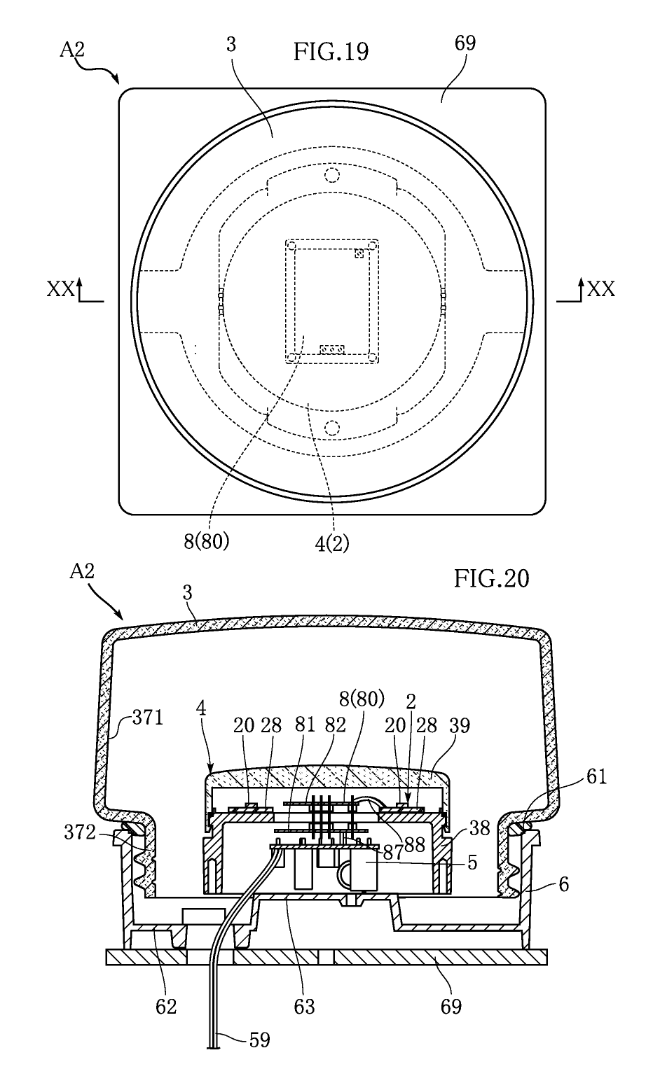

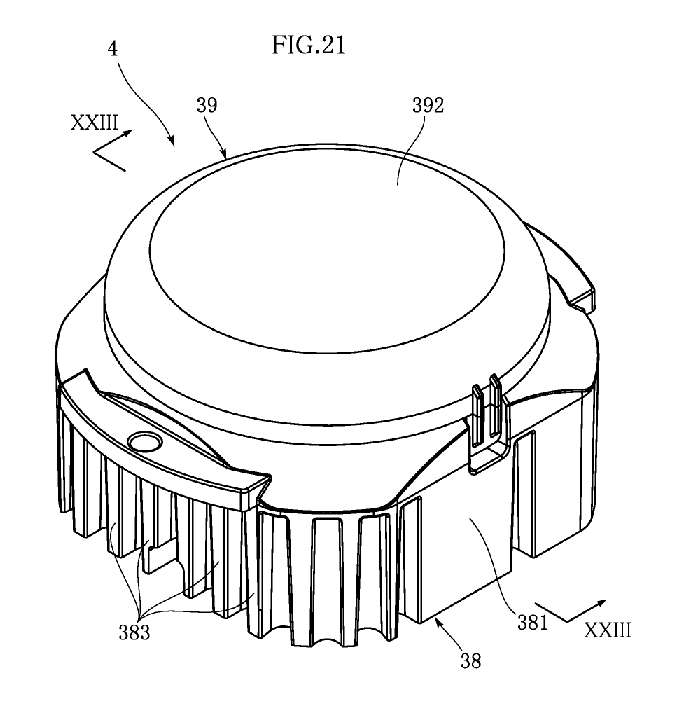

FIGS. 19 and 20 show an LED lighting apparatus according to a second embodiment of the present invention. An LED lighting apparatus A2 according to the present embodiment includes an LED unit 4, a case 6, a translucent cover 3, and a radar switching unit 8. The LED lighting apparatus A2 is a type of lighting fixture that is to be attached to a ceiling or a wall.

FIG. 19 is a plan view showing the LED lighting apparatus A2. FIG. 20 is a cross-sectional view along the line XX-XX in FIG. 19.

The case 6 has a bottomed tubular shape, and has an opening 61, a bottom plate portion 62, and a mount 63. In the present embodiment, the case 6 is cylindrical. The case 6 is made of a metal such as aluminum. In the present embodiment, the direction in which the opening 61 faces (i.e., upward in the figure, which is the main emission direction) is sometimes referred to as an opening direction. The case 6 of the present embodiment is supported by a base 69. The base 69 is a plate-like member made of metal or resin, and serves as a foundation when the LED lighting apparatus A2 is attached to a ceiling or a wall.

The bottom plate portion 62 is positioned opposite to the opening direction. The bottom plate portion 62 is a substantially plate-like portion that is annular in plan view. The mount 63 is a circular portion surrounded by the bottom plate portion 62 in plan view. The mount 63 is positioned more forward in the opening direction than the bottom plate portion 62. The LED unit 4 is attached to the mount 63.

The translucent cover 3 covers the opening 61 of the case 6, and allows the light from a LED light-emitting unit 2 and the radio waves from a radar detector 80 to pass through. The translucent cover 3 allows the light from the LED light-emitting unit 2 to pass through and diffuse, and is made of a semi-transparent opaque white material, for example. The translucent cover 3 is made of resin or glass. The translucent cover 3 made of such a material does not allow the radio waves from the radar detector 80 to pass through completely, but rather allows some of the radio waves to pass through while reflecting the others.

In the present embodiment, the translucent cover 3 has a substantially cylindrical shape so as to conform to the case 6 having a substantially cylindrical shape. The translucent cover 3 has an inner circumferential surface 371 that stands erect from the opening 61 of the case 6 in the opening direction of the opening 61. The inner circumferential surface 371 of the present embodiment is substantially cylindrical. The translucent cover 3 has a shape in which the cross-sectional dimension (i.e., diameter) gradually decreases with increasing distance from the case 6 in the opening direction. The translucent cover 3 is attached to the case 6 by any of various means such as threading, jointing, or fastening. The translucent cover 3 further has an inner tubular portion 372. The inner tubular portion 372 is located opposite to the opening direction relative to the inner circumferential surface 371, and has a smaller diameter than the inner circumferential surface 371. The inner tubular portion 372 is almost entirely housed in the case 6.

The LED unit 4 includes the LED light-emitting unit 2, a heat dissipater 38, an inner cover 39, and a power unit 5. As shown in FIG. 20, the LED unit 4 is fixed to the bottom of the case 6, and is housed in the case 6 and the translucent cover 3. In the present embodiment, a part of the LED unit 4 protrudes in the opening direction from the opening 61 of the case 6. As shown in FIG. 19, the centers of the case 6 and the translucent cover 3 substantially coincide with the center of the LED unit 4.

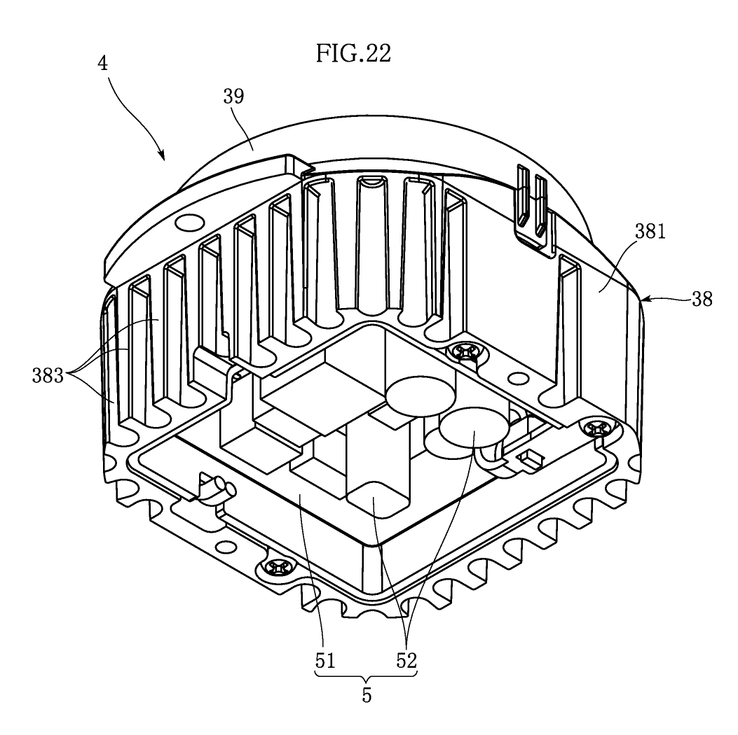

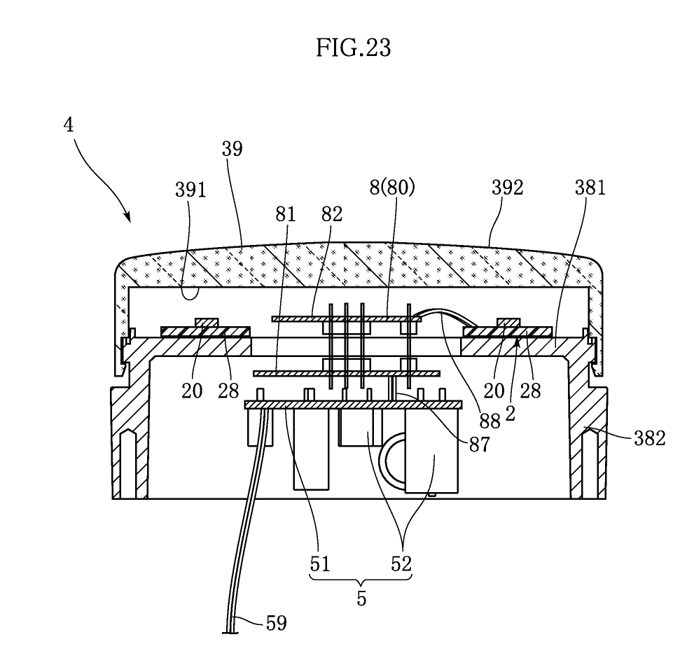

FIGS. 21 and 22 are perspective views showing the LED unit 4. FIG. 23 is a cross-sectional view along the line XXIII-XXIII in FIG. 21.

The LED light-emitting unit 2 is a light source of the LED unit 4. The LED light-emitting unit 2 has substantially the same structure as the LED light-emitting unit 2 of the LED lighting apparatus A1 described above.

The heat dissipater 38 has the LED light-emitting unit 2 attached thereto, and facilitates dissipation of heat generated from the LED light-emitting unit 2 when lit. The heat dissipater 38 has a top plate portion 381 and a tubular portion 382.

The top plate portion 381 is a flat plate-like portion perpendicular to the opening direction of the case 6. In the present embodiment, the top plate portion 381 is substantially rectangular in plan view. The LED light-emitting unit 2 is attached to an upper surface of the top plate portion 381 in the figures.

The tubular portion 382 has a tubular shape and extends from the top plate portion 381 in a direction opposite to the upper surface to which the LED light-emitting unit 2 is attached (i.e., extends backward in the main emission direction). In the present embodiment, the tubular portion 382 has a substantially square tubular shape. The tubular portion 382 has a plurality of fins 383. The plurality of fins 383 protrude outward from the tubular portion 382. The plurality of fins 383 extend along the opening direction and are arranged parallel to each other.

The inner cover 39 is attached to the heat dissipater 38 and allows the light from the LED light-emitting unit 2 to pass through. In the present embodiment, the inner cover 39 allows the light from the LED light-emitting unit 2 to pass through and diffuse, and is made of a semi-transparent opaque white material, for example. The inner cover 39 as described above is made of resin or glass. The inner cover 39 allows at least some of the radio waves from the radar detector 30 to pass through.

The inner cover 39 has a light-incident flat surface 391 and a light-emitting curved surface 392.

The light-incident flat surface 391 directly faces the LED light-emitting unit 2, and receives the light from the LED light-emitting unit 2. In the present embodiment, the light-incident flat surface 391 is rough.

The light-emitting curved surface 392 is arranged opposite to the light-incident flat surface 391 (i.e., on the upper side in the figures), and bulges outward. The light-emitting curved surface 392 is as rough as the light-incident flat surface 391.

The power unit 5 converts, for example, commercial AC power of 100 V to DC power suitable for lighting the plurality of LED chips 22 of the LED light-emitting unit 2. The power unit 5 is housed in the tubular portion 382 of the heat dissipater 38.

According to the present embodiment, the power unit 5 is composed of a power substrate 51 and a plurality of electronic components 52.

The power substrate 51 serves as a base for the power unit 5, and supports the plurality of electronic components 52. In addition, the power substrate 51 has a conduction path that electrically connects the plurality of electronic components 52 as necessary. In the present embodiment, as shown in FIG. 23, the power substrate 51 is arranged at an upper side of the tubular portion 382 in the figure (i.e., closer to the top plate portion 381).

The plurality of electronic components 52 constitute a power circuit that realizes the function of the power unit 5. Examples of the plurality of electronic components 52 include transformers, capacitors, resistors, and diodes; however, the types and specifications of the plurality of electronic components 52 are not limited to such.

The power unit 5 is connected to a cable 57, a cable 58, and a cable 59. The cable 57 connects the power unit 5 and the radar switching unit 8. The cable 58 supplies power from the power unit 5 to the LED light-emitting unit 2, and is connected to the power unit 5 and the LED light-emitting unit 2. The cable 59 leads power received from an external source to the power unit 5.

The radar switching unit 8 has the same structure as the radar switching unit 8 of the LED lighting apparatus A1 described above. Any of the structures shown in FIGS. 2, 14, and 15 can be appropriately employed so as to establish a positional relationship between a main substrate 81 and a sensor substrate 82 of the radar switching unit 8 and an LED substrate 28 of the LED light-emitting unit 2.

Such an embodiment can also save power without cumbersome operations. In addition, since the LED unit 1 includes the heat dissipater 38, dissipation of heat generated from the LED light-emitting unit 2 can be facilitated. The heat dissipater 38 as described above is made of a metal such as aluminum. The sensor substrate 82 of the radar switching unit 8 is arranged in the exterior of the heat dissipater 38 having the aforementioned structure, and this arrangement is preferable to in suppressing a decrease in the detection sensitivity of the radar switching unit 8.

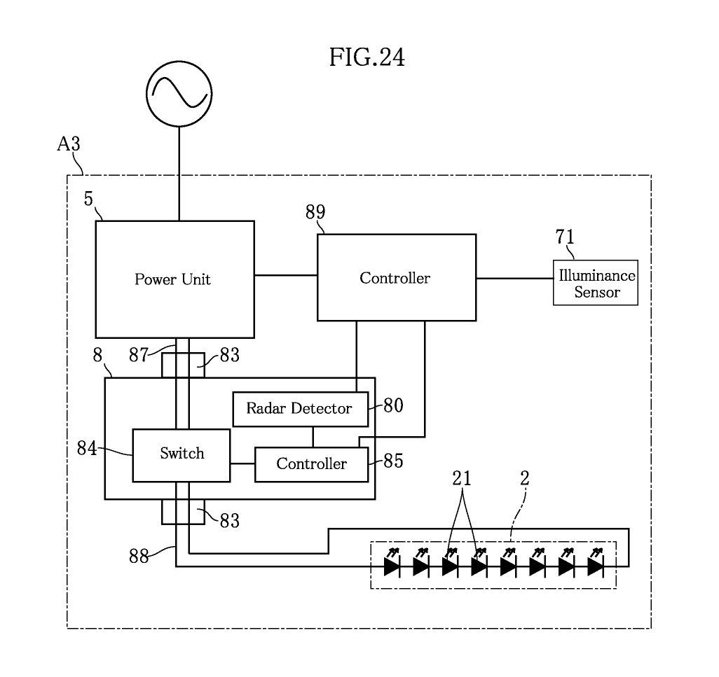

FIG. 24 is a system configuration diagram showing an LED lighting apparatus according to a third embodiment of the present invention. The present embodiment differs from the above-described embodiments in that an LED lighting apparatus A3 according to the present embodiment includes an illuminance sensor 71. The illuminance sensor 71 detects the brightness of the environment in which the LED lighting apparatus A3 is placed. Specific examples of the illuminance sensor 71 include a phototransistor, a photodiode, and a sensor IC on which these components are mounted.

A detection signal from the illuminance sensor 71 is input into a controller 89. The controller 89 of the present embodiment uses the detection signal from the illuminance sensor 71 to control the light emission of an LED light-emitting unit 2.

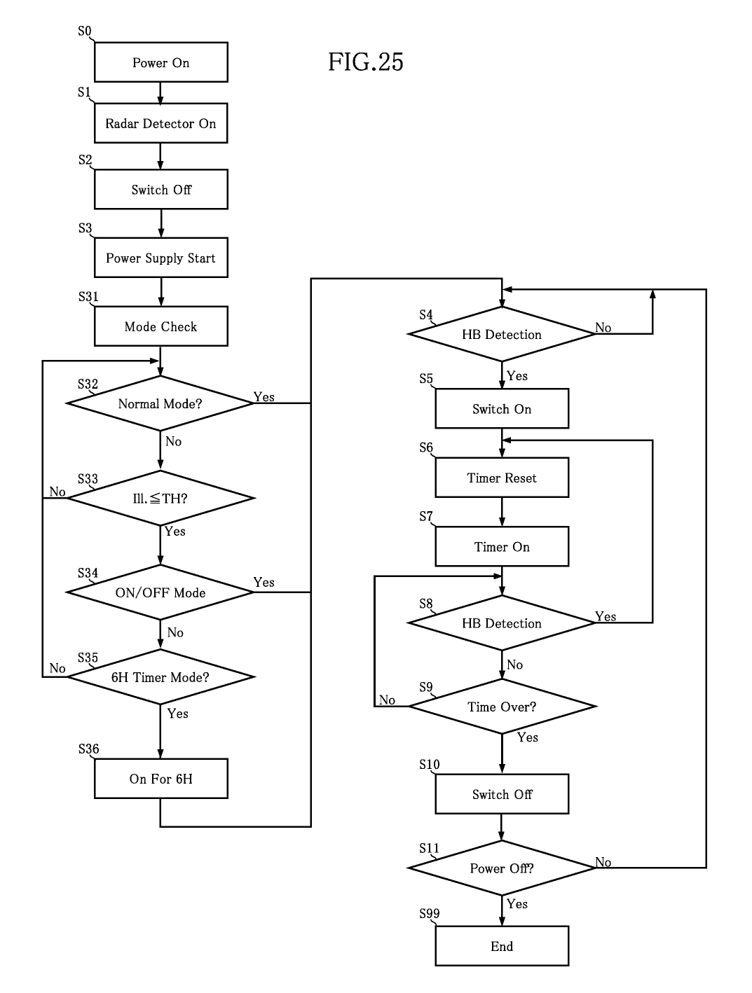

FIG. 25 is a flowchart showing an example of the operation of the LED lighting apparatus A3. After the above-described steps S0 to S3 are performed, the controller 89 performs a mode check (step S31). When the mode is set to a normal mode (step S32: Yes), steps from step S4 onward are performed.

When the mode is not set to a normal mode (step S32: No), the controller 89 determines (step S33) whether the illuminance (“Ill.”) is less than or equal to a predetermined value or threshold (“TH”), as denoted by “Ill.≦TH”. This determination is performed by comparing whether the illuminance of the environment in which the LED lighting apparatus A3 is placed is less than or equal to the predetermined illuminance, based on the detection signal from the illuminance sensor 71. The predetermined illuminance corresponds to the illuminance in the evening or at night, for example.

If the illuminance is not less than or equal to the predetermined illuminance (step S33: No), the process returns to step S32. If the illuminance is less than or equal to the predetermined illuminance (step S33: Yes), the controller 89 checks whether the mode is ON/OFF mode (step S34). If the mode is set to ON/OFF mode (step S34: Yes), steps from step S4 onward are performed.

If the mode is not set to ON/OFF mode (step S34: No), the controller 89 checks whether the mode is 6-hour timer mode (step S35). When the mode is set to 6-hour timer mode (step S35: Yes), the controller 89 lights the LED light-emitting unit 2 continuously for 6 hours (step S36). Note that 6 hours is merely an example of a preset continuous lighting time, and another time length such as 8 hours may be employed instead. After the LED light-emitting unit 2 is lit continuously for 6 hours (step S36), steps from step S4 onward are performed. When the mode is not set to 6-hour timer mode (step S35: No), the process returns to step S32. Such an embodiment can also save power without cumbersome operations.

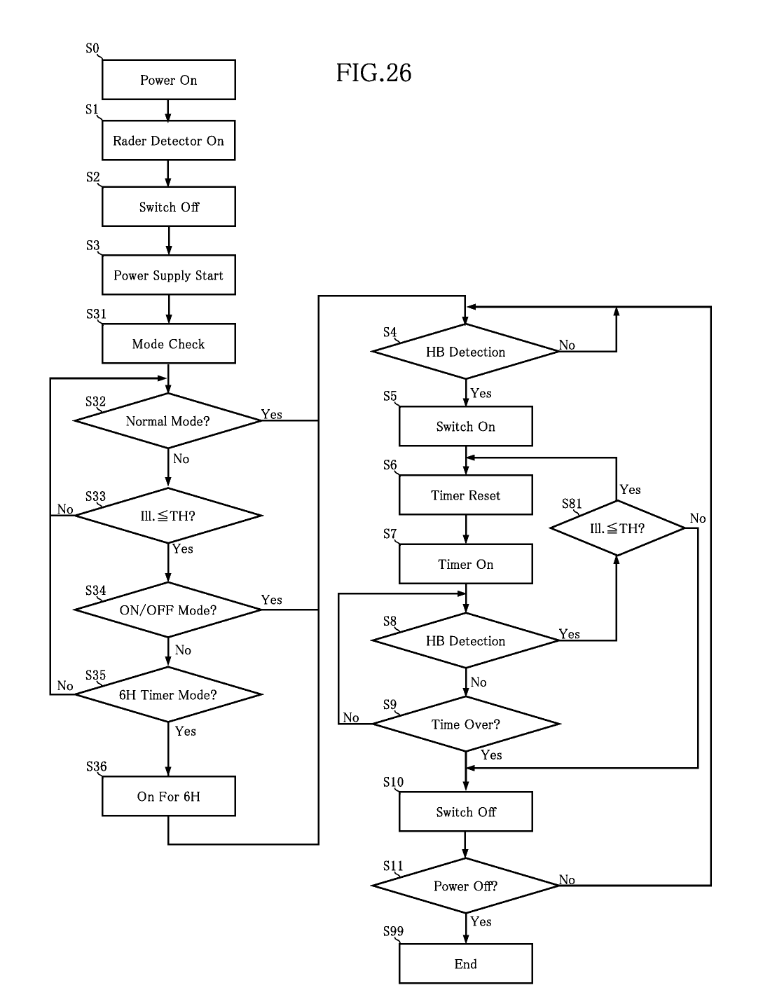

FIG. 26 is a flowchart showing another example of the operation of the LED lighting apparatus A3. In this example, step S81 is performed if the detection result in the above-described step S8 is in the affirmative (S8: Yes).

In step S81, the controller 89 compares whether the illuminance of the environment in which the LED lighting apparatus A3 is placed is less than or equal to the predetermined illuminance, based on the detection signal from the illuminance sensor 71. The predetermined illuminance corresponds to the illuminance in the evening or at night, for example.

If the illuminance is less than or equal to the predetermined illuminance (step S81: Yes), the above-described step S6 is performed. If the illuminance is not less than or equal to the predetermined illuminance (step S81: No), the above-described step S10 is performed.

According to the operational example as described above, after the user HM is detected in step S8, if the illuminance of the environment is less than or equal to the predetermined illuminance, lighting is continued, and if the illuminance of the environment is not less than or equal to the predetermined illuminance, lighting is stopped. Accordingly, when the illuminance of the environment is higher than the predetermined illuminance, wasteful lighting can be reduced to advantageously save power.

The LED lighting apparatus according to the present invention should not be limited to the embodiments described above. Various design changes can be made to the specific configurations of the elements of LED lighting apparatuses according to the present invention.

The reference signs in FIGS. 27 to 41, as well as the reference signs and terms used for LED lighting apparatuses A4 and A5 in fourth to fifth embodiments described below with reference to FIGS. 27 to 41, are only in effect within the said embodiments. These reference signs and terms are independent from the reference signs in FIGS. 1 to 26 and the reference signs and terms used for the LED lighting apparatuses A1 to A3 in the first and third embodiments described with reference to FIGS. 1 to 26.

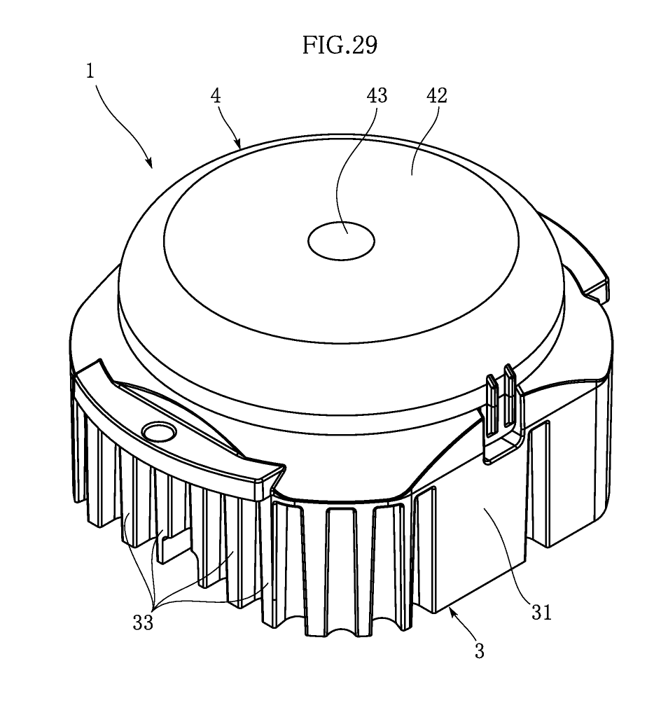

FIGS. 27 and 28 show an LED lighting apparatus according to a fourth embodiment of the present invention. An LED lighting apparatus A4 according to the present embodiment includes an LED unit 1, a case 6, a translucent cover 7, and a radar switching unit 8. The LED lighting apparatus A4 is a type of lighting fixture that is to be attached to a ceiling or a wall.

FIG. 27 is a plan view showing the LED lighting apparatus A4. FIG. 28 is a cross-sectional view along the line XXVIII-XXVIII in FIG. 27.

The case 6 has a bottomed tubular shape, and has an opening 61, a bottom plate portion 62, and a mount 63. In the present embodiment, the case 6 is cylindrical. The case 6 is made of a metal such as aluminum. In the present embodiment, the direction in which the opening 61 faces (i.e., upward in the figure) is sometimes referred to as an opening direction. The case 6 of the present embodiment is supported by a base 69. The base 69 is a plate-like member made of metal or resin, and serves as a foundation when the LED lighting apparatus A4 is attached to a ceiling or a wall.

The bottom plate portion 62 is positioned opposite to the opening direction. The bottom plate portion 62 is a substantially plate-like portion that is annular in plan view. The mount 63 is a circular portion surrounded by the bottom plate portion 62 in plan view. The mount 63 is positioned more forward in the opening direction than the bottom plate portion 62. The LED unit 1 is attached to the mount 63.

The translucent cover 7 covers the opening 61 of the case 6, and allows the light from an LED light-emitting unit 2 and the radio waves from a radar detector 80 to pass through. The translucent cover 7 allows the light from the LED light-emitting unit. 2 to pass through and diffuse, and is made of a semi-transparent opaque white material, for example. The translucent cover 7 is made of resin or glass. The translucent cover 7 made of such a material does not allow the radio waves from the radar detector 80 to pass through completely, but rather allows some of the radio waves to pass through while reflecting the others.

In the present embodiment, the translucent cover 7 has a substantially cylindrical shape so as to conform to the case 6 having a substantially cylindrical shape. The translucent cover 7 has an inner circumferential surface 71 that stands erect from the opening 61 of the case 6 in the opening direction of the opening 61. The inner circumferential surface 71 of the present embodiment is substantially cylindrical. The translucent cover 7 has a shape in which the cross-sectional dimension (i.e., diameter) gradually decreases with increasing distance from the case 6 in the opening direction. The translucent cover 7 is attached to the case 6 by any of various means such as threading, jointing, or fastening. The translucent cover 7 further has an inner tubular portion 72. The inner tubular portion 72 is located opposite to the opening direction relative to the inner circumferential surface 71, and has a smaller diameter than the inner circumferential surface 71. The inner tubular portion 72 is almost entirely housed in the case 6.

The LED unit 1 includes an LED light-emitting unit 2, a heat dissipater 3, an inner cover 4, and a power unit 5. As shown in FIG. 28, the LED unit 1 is fixed to the bottom of the case 6, and is housed in the case 6 and the translucent cover 7. In the present embodiment, a part of the LED unit 1 protrudes in the opening direction from the opening 61 of the case 6. As shown in FIG. 27, the centers of the case 6 and the translucent cover 7 substantially coincide with the center of the LED unit 1.

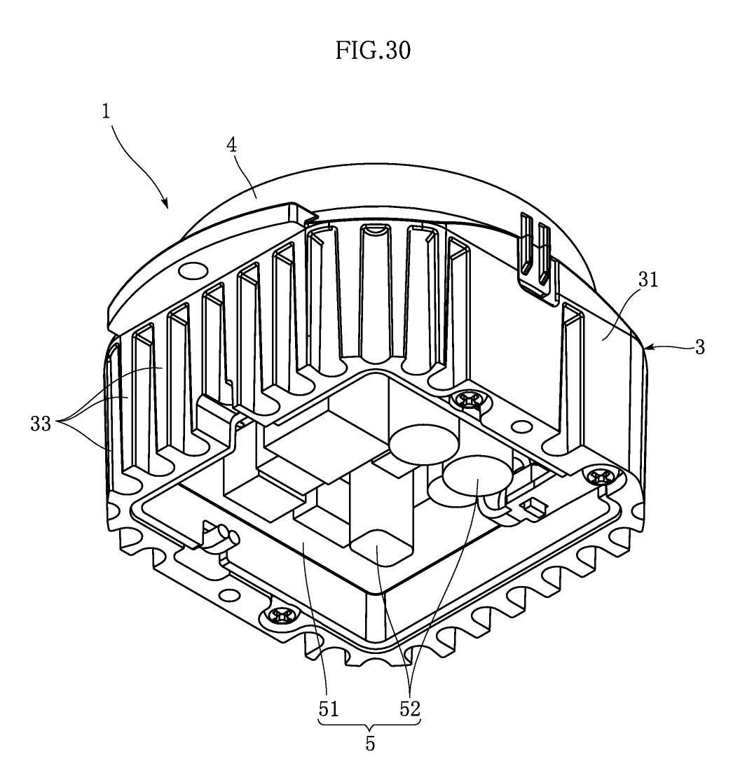

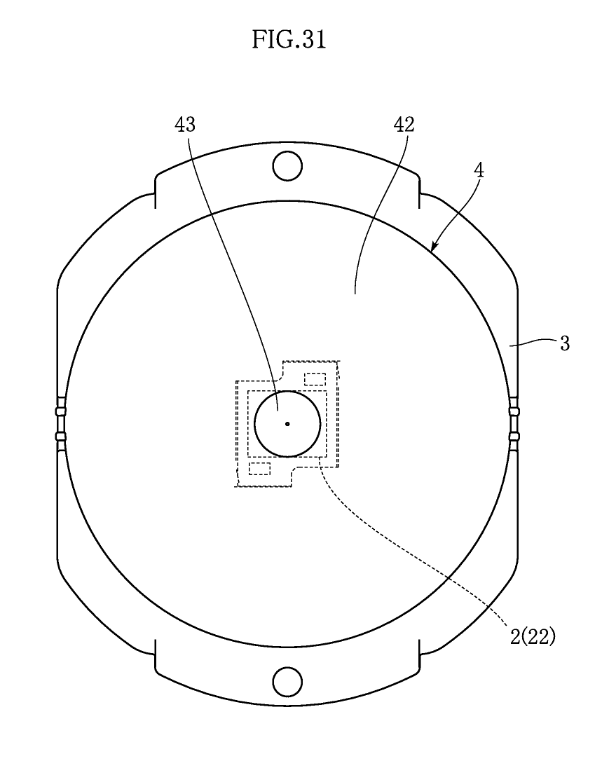

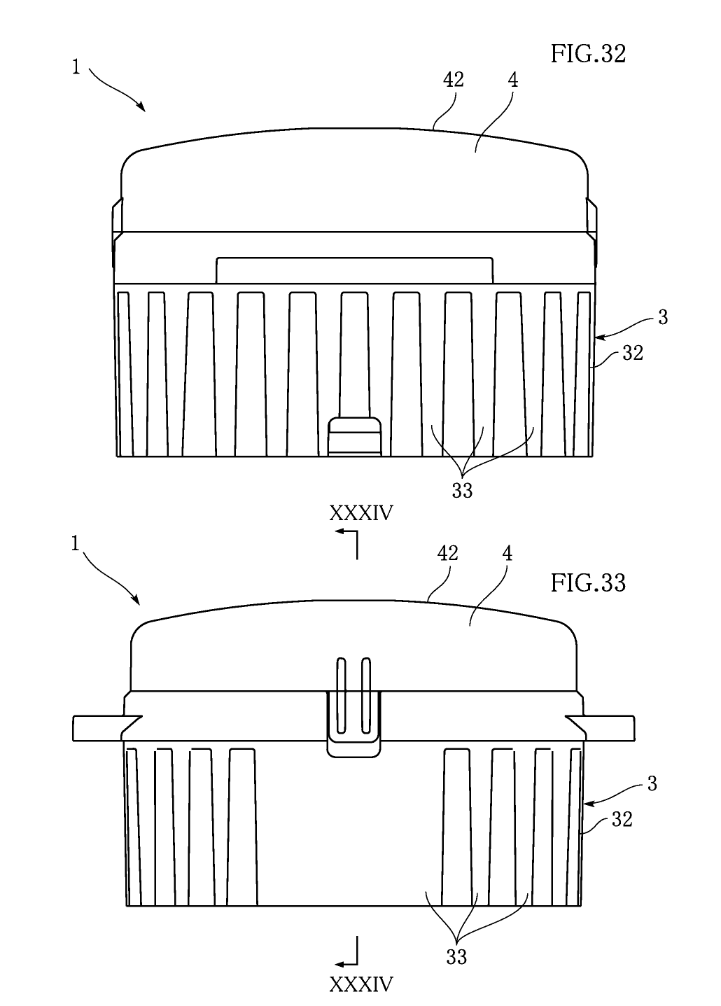

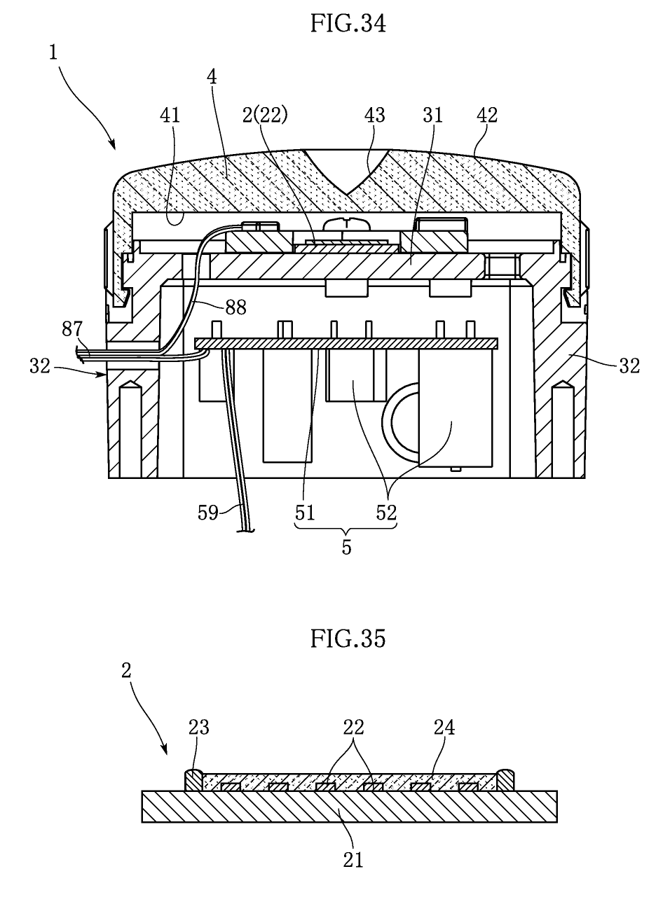

FIGS. 29 and 30 are perspective views showing the LED unit 1. FIG. 31 is a plan view showing the LED unit 1. FIG. 32 is a front view showing the LED unit 1. FIG. 33 is a side view showing the LED unit 1. FIG. 34 is a cross-sectional view along the line XXXIV-XXXIV in FIG. 33.

The LED light-emitting unit 2 is a light source of the LED unit 1. FIG. 35 is an enlarged cross-sectional view showing the LED light-emitting unit 2. As shown in FIG. 35, the LED light-emitting unit 2 of the present embodiment includes an LED substrate 21, a plurality of LED chips 22, a dam 23, and sealing resin 24.

The LED substrate 21 supports the plurality of LED chips 22 and has a conduction path to these LED chips. Although the specific structure of the LED substrate 21 is not particularly limited, the LED substrate 21 may be made up of a base and a wiring pattern, for example. The base is made of insulating material, such as glass epoxy resin or ceramics with improved heat conductivity. The wiring pattern has the plurality of LED chips 22 mounted thereon, and serves as a conduction path to the LED chips 22. The wiring pattern is formed by a metal plating layer made of, for example, copper (Cu), nickel (Ni), gold (Au), or silver (Ag), for example.

The plurality of LED chips 22 are light-emitting elements of the LED light-emitting unit 2. The LED chips 22 may have GaN-based semiconductor layers, and may emit blue light. In the present embodiment, the plurality of LED chips 22 are mounted on the LED substrate 21 substantially in a matrix. The LED chips 22 are two-wire LED chips, but may be one-wire LED chips or flip-chip LED chips.

The dam 23 is formed on the LED substrate 21, and surrounds the plurality of LED chips 22. In the present embodiment, the dam 23 has a rectangular ring shape in plan view, and is made of white silicone resin or epoxy resin, for example. The dam 23 is taller than the LED chips 22.

The sealing resin 24 covers the plurality of LED chips 22, and fills an area surrounded by the dam 23. For example, the sealing resin 24 is made of transparent resin, such as silicone resin or epoxy resin, and a fluorescent substance mixed in the transparent resin. The fluorescent substance emits yellow light as a result of excitation by the blue light from the LED chips 22. Alternatively, it is possible to use a mix of a fluorescent substance that emits red light and a fluorescent substance that emits green light, as a result of excitation by the blue light from the LED chips 22. This causes the LED light-emitting unit 2 to emit light that is white or near-white in color such as incandescent or daylight.

The heat dissipater 3 has the LED light-emitting unit 2 attached thereto, and facilitates dissipation of heat generated from the LED light-emitting unit 2 when lit. The heat dissipater 3 has a top plate portion 31 and a tubular portion 32.

The top plate portion 31 is a flat plate-like portion perpendicular to the opening direction of the case 6. In the present embodiment, the top plate portion 31 is substantially rectangular in plan view. The LED light-emitting unit 2 is attached to an upper surface of the top plate portion 31 in the figures.

The tubular portion 32 has a tubular shape and extends from the top plate portion 31 in a direction opposite to the upper surface to which the LED light-emitting unit 2 is attached (i.e., extends backward in the main emission direction). In the present embodiment, the tubular portion 32 has a substantially square tubular shape. The tubular portion 32 has a plurality of fins 33. The plurality of fins 33 protrude outward from the tubular portion 32. The plurality of fins 33 extend along the opening direction and are arranged parallel to each other.

The inner cover 4 is attached to the heat dissipater 3 and allows the light from the LED light-emitting unit 2 to pass through. In the present embodiment, the inner cover 4 allows the light from the LED light-emitting unit 2 to pass through and diffuse, and is made of a semi-transparent opaque white material, for example. The inner cover 4 as described above is made of resin or glass.

The inner cover 4 has a light-incident flat surface 41, a light-emitting curved surface 42, and a recessed surface 43.

The light-incident flat surface 41 directly faces the LED light-emitting unit 2, and receives the light from the LED light-emitting unit 2. In the present embodiment, the light-incident flat surface 41 is rough.

The light-emitting curved surface 42 is arranged opposite to the light-incident flat surface 41 (i.e., on the upper side in the figures), and bulges outward. The light-emitting curved surface 42 is as rough as the light-incident flat surface 41.

The recessed surface 43 is recessed from the light-emitting curved surface 42. In the present embodiment, the recessed surface 43 is cone-shaped. Also, as shown in FIG. 31, the recessed surface 43 overlaps the LED light-emitting unit 2 in plan view. Furthermore, in the present embodiment, the center of the recessed surface 43 in plan view coincides with the center of the LED light-emitting unit 2 in plan view. The recessed surface 43 is smooth relative to the light-incident flat surface 41 and the light-emitting curved surface 42.

The power unit 5 converts, for example, commercial AC power of 100 V to DC power suitable for lighting the plurality of LED chips 22 of the LED light-emitting unit 2. The power unit 5 is housed in the tubular portion 32 of the heat dissipater 3.

According to the present embodiment, the power unit 5 is composed of a power substrate 51 and a plurality of electronic components 52.

The power substrate 51 serves as a base for the power unit 5, and supports the plurality of electronic components 52. In addition, the power substrate 51 has a conduction path that electrically connects the plurality of electronic components 52 as necessary. In the present embodiment, as shown in FIG. 34, the power substrate 51 is arranged at an upper side of the tubular portion 32 in the figure (i.e., closer to the top plate portion 31).

The plurality of electronic components 52 constitute a power circuit that realizes the function of the power unit 5. Examples of the plurality of electronic components 52 include transformers, capacitors, resistors, and diodes; however, the types and specifications of the plurality of electronic components 52 are not limited to such.

The power unit 5 is connected to a cable 59. The cable 59 leads power received from an external source to the power unit 5.

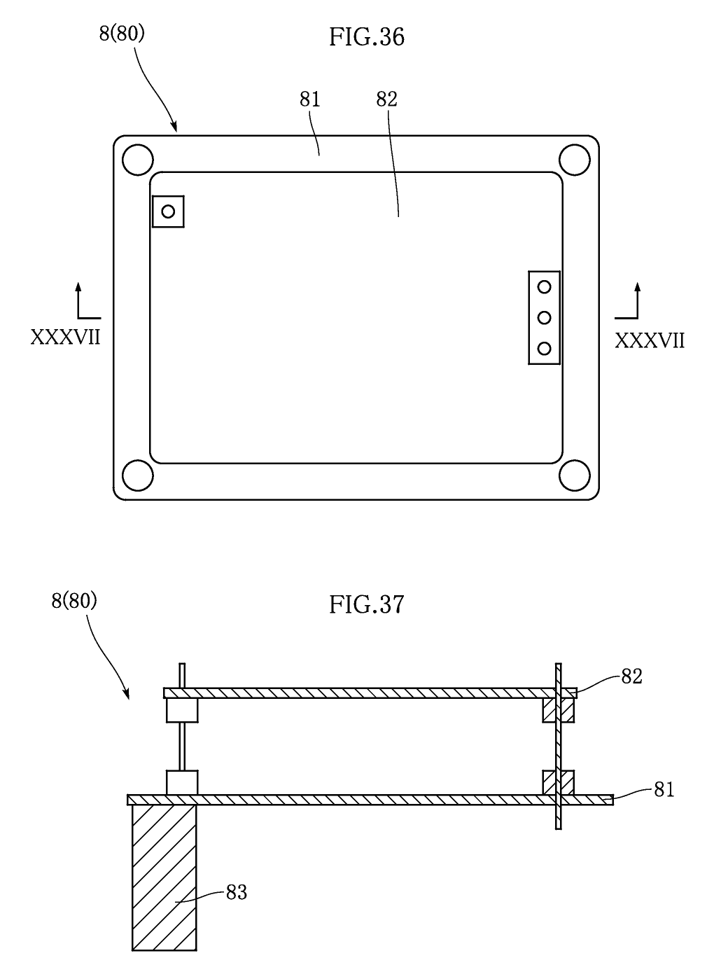

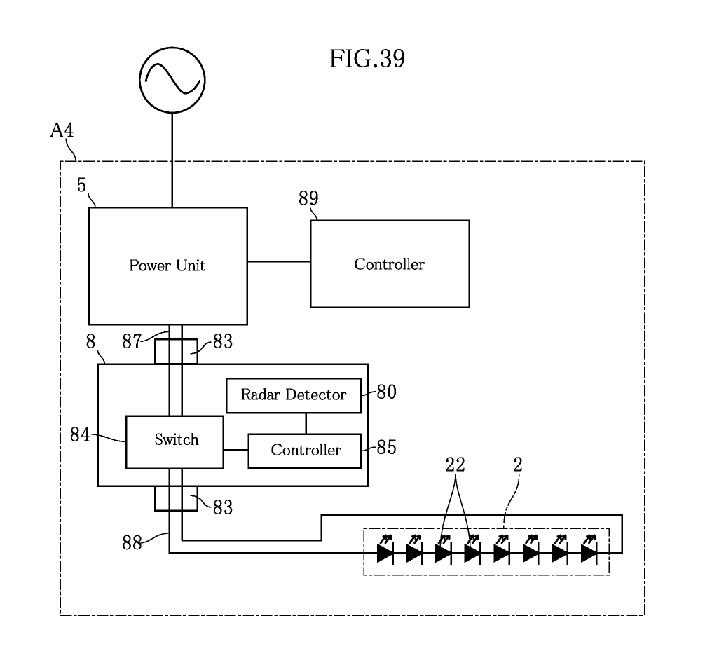

FIG. 36 is a plan view showing the radar switching unit 8. FIG. 37 is a cross-sectional view along the line XXXVII-XXXVII in FIG. 36. FIG. 39 is a system configuration diagram showing the LED lighting apparatus A4.

The radar switching unit 8 includes a radar detector 80, a main substrate 81, a sensor substrate 82, a connector 83, a switch 84, and a controller 85.

The radar detector 80 detects the movement of an object based on the transmission of radio waves, reception of the radio waves reflected by the object, and Doppler effect of the received radio waves that is a change in a wavelength of the received radio waves due to the movement of the object. In the present embodiment, a transmission device and a reception device for the radar detector 80 are mounted on the sensor substrate 82.

The main substrate 81 is, for example, a substrate on which the switch 84 and the controller 85 are mounted. The main substrate 81 is a wiring substrate having a base member that is made of glass epoxy resin, for example.

The sensor substrate 82 is, for example, a substrate on which the transmission device and reception device of the radar detector 80 are mounted. The sensor substrate 82 is a wiring substrate having a base member that is made of glass epoxy resin, for example.

The connector 83 connects the radar switching unit 8 to the LED light-emitting unit 2 and the power unit 5. In the present embodiment, the connector 83 is attached to the main substrate 81 and protrudes downward in the figure.

The switch 84 is arranged in a current path so as to turn on and off the current flowing in the current path. In the present embodiment, the switch 84 is mounted on the main substrate 81.

The controller 85 controls the radar switching unit 8 to perform necessary functions, and is typically an IC, for example. For example, the controller 85 receives a detection signal from the radar detector 80, and controls the switch 84 to turn on/off based on the detection signal.

As shown in FIG. 28, the radar detector 80 is housed in the case 6 at a position deeper than the LED light-emitting unit 2 in a depth direction of the case 6. The radar switching unit 8 is arranged in the exterior of the LED unit 1. In the present embodiment, the radar switching unit 8 is arranged at a position deeper than the opening 61 of the case 6 in the depth direction of the case 6. That is, the radar switching unit 8 is arranged at a position deeper in the depth direction of the case 6 than a portion of the translucent cover 7 exposed from the case 6. The radar switching unit 8 includes a portion deeper than the LED unit 1 in the depth direction. Specifically, the main substrate 81 and the connector 83 of the radar switching unit 8 are positioned more downward in FIG. 28 than the heat dissipater 3 of the LED unit 1.

As compared to the mount 63 of the case 6, the sensor substrate 82 is positioned forward in the opening direction (i.e., upward in FIG. 28), whereas the main substrate 81 is positioned backward in the opening direction (i.e., downward in FIG. 28). Similarly, as compared to a lower end of the heat dissipater 3 in FIG. 28, the sensor substrate 82 is positioned forward in the opening direction (i.e., upward in FIG. 28), whereas the main substrate 81 is positioned backward in the opening direction (i.e., downward in FIG. 28). Furthermore, as compared to a lower end of the inner tubular portion 72 of the translucent cover 7, the sensor substrate 32 is positioned forward in the opening direction (i.e., upward in FIG. 28), whereas the main substrate 81 is positioned backward in the opening direction (i.e., downward in FIG. 28).

As shown in FIG. 39, the radar switching unit 8 is electrically interposed between the power unit 5 and the LED light-emitting unit 2. That is, the conduction path connecting the power unit 5 and the LED light-emitting unit 2 is switched between an open state and a blocked state by the switch 84 of the radar switching unit 8.

The LED lighting apparatus A4 includes a first cable 87 and a second cable 88. The first cable 87 connects the power unit 5 and the radar switching unit 8. The second cable 88 connects the radar switching unit 8 and the LED light-emitting unit 2. That is, the power supplied from the power unit 5 is transferred, via the first cable 87, from the heat dissipater 3 of the LED unit 1 to the exterior of the LED unit 1, and is input to the switch 84 of the radar switching unit 8. Subsequently, the power output from the switch 84 returns, via the second cable 88, from the radar switching unit 8 to the interior of the heat dissipater 3 of the LED unit 1, and is then lead to the LED light-emitting unit 2 within the LED unit 1.

The LED lighting apparatus A4 includes a controller 89. For example, the controller 89 transmits a command relating to the power supply state of the power unit 5. Note that the functions of the controller 89 may be incorporated into the power unit 5.

Next, an operation of the LED lighting apparatus A4 will be described with reference to FIGS. 33 and 39.

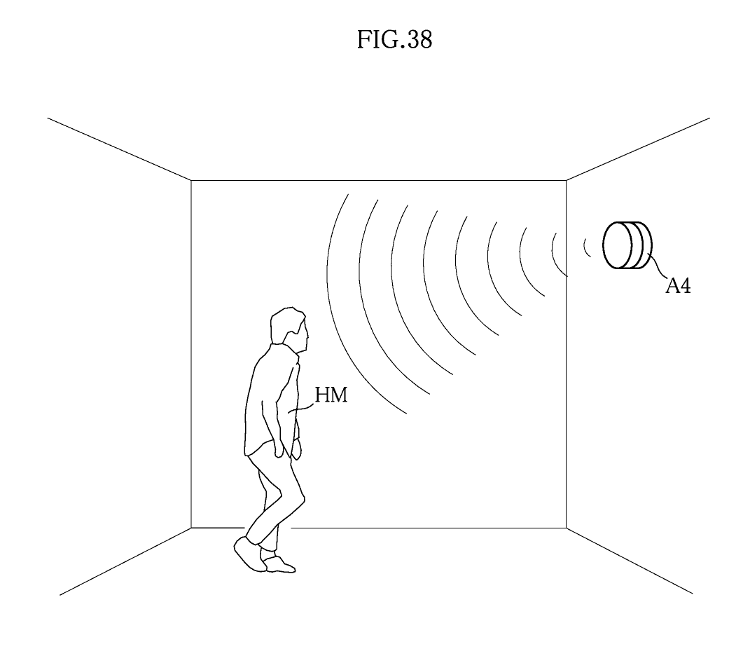

FIG. 38 shows one form of the environment in which the LED lighting apparatus A4 is used. In this figure, the LED lighting apparatus A4 is installed in a room having a floor, a wall, a ceiling, and so on. In the illustrated example, the LED lighting apparatus A4 is attached to the wall. The use mode in the figure is an example showing one of the use modes of the LED lighting apparatus A4. The LED lighting apparatus A4 may be attached to various indoor or outdoor objects. The description below provides an example of the operation of the LED lighting apparatus A4 when a user HM walks into this room.

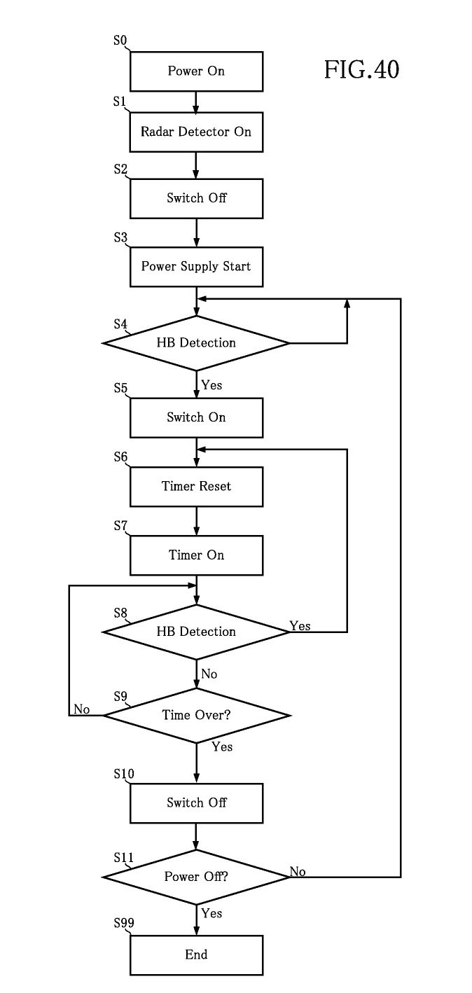

FIG. 40 is a flowchart showing the operation of the LED lighting apparatus A4. First, in step S0, the LED lighting apparatus A4 is powered on. In step S1, an initialization process is performed so that the radar detector 80 is placed in ON state and the transmission and reception of radio waves is started. In step S2, the switch 84 of the radar switching unit 8 is placed in OFF state by the controller 85. As a result, the LED light-emitting unit 2 is placed in a light-off state. In step S3, the power unit 5 starts to supply power to light the LED light-emitting unit 2.

Next, in step S4, a human body detection is performed. Note that the radar detector 80 of the radar switching unit 8 can detect an object other than a human body due to its principle. If the user HM is not in the room (step S4: No), the controller 85 maintains the switch 84 at OFF state and performs step S4 again.

If the user HM is detected in the room (step S4: Yes), the controller 85 switches the switch 84 to ON state, based on a detection signal from the radar detector 80. This allows the power from the power unit 5 to be supplied to the LED light-emitting unit 2 via the first cable 87, the switch 84, and the second cable 88. As a result, the LED light-emitting unit 2 lights up, and the room is illuminated by the LED lighting apparatus A4.

Next, in step S6, a timer in the controller 85 is reset, and in step S7, counting by the timer is started. If the user HM is not detected in step S8 (step S8: No), a determination is performed, in step S9, as to whether the count of the timer has reached a predetermined light-up expiry time. If the count has not reached the light-up expiry time (step S9: No), step S8 is repeated.

If the user HM is re-detected in step S8 (step S8: Yes), the controller 85 performs step S6 to reset the timer, and the counting by the timer in step S7 is restarted.

When the count reaches the light-up expiry time in step S9 (step S9: Yes), the controller 85 switches the switch 84 to OFF state in step S10. As a result, the power supply to the LED light-emitting unit 2 is cut off, causing the LED lighting apparatus A4 to be turned off.

If a power-off operation is not performed in step S11 (step S11: No), steps from step S4 onward are performed in sequence. On the other hand, if a power-off operation is performed (step S11: Yes), all processes are ended and the power is turned off.

Next, advantages of the LED lighting apparatus A4 will be described.

According to the present embodiment, whether the user HM or the like is present in a target environment can be detected by the radar detector 80. Since the light emission of the LED light-emitting unit 2 is controlled based on a detection signal of the radar detector 80, the LED light-emitting unit 2 is caused to emit light at a necessary timing without special operations. The LED lighting apparatus A4 can therefore save power without cumbersome operations. In addition, the radar detector 80 is arranged in the case 6 at a position deeper than the LED light-emitting unit 2. In this way, when mounted, the radar detector 80 does not unreasonably narrow the installation region of the LED light-emitting unit 2. This makes it possible to achieve light-up control based on the presence or absence of an object, and to suppress a decrease in the luminance of the LED lighting apparatus A4.

The translucent cover 7 allows the light from the LED light-emitting unit 2 to pass through and diffuse. In this way, the radar detector 80 in the LED lighting apparatus A4 is barely recognizable from the exterior of the LED lighting apparatus A4. The translucent cover 7 made of resin or glass is preferable in allowing radio waves and light to pass through.

The case 6 is made of metal, and the radar detector 80 is arranged at the depth of the case 6. The case 6 made of metal allows almost no radio waves to pass through. However, the translucent cover 7 has the inner circumferential surface 71 that stands erect from the opening 61 of the case 6 in the opening direction of the opening 61. With such a structure, the radio waves transmitted from the radar detector 80, reflected by an object, and then arriving at the inner circumferential surface 71 are reflected by the inner circumferential surface 71. Without the inner circumferential surface 71, radio waves would travel to the exterior of the LED lighting apparatus A4. However, such radio waves can be directed to the radar detector 80 by the reflection at the inner circumferential surface 71. This makes it possible to arrange the radar detector 80 at the depth of the case 6, and to still suppress a decrease in the detection sensitivity of the radar detector 80. In addition, since the sensor substrate 82 is arranged more forward than the mount 63 of the case 6 in the opening direction (i.e., upward in FIG. 28), the sensor substrate 82 can receive, with high sensitivity, the radio waves travelled into the case 6. On the other hand, the main substrate 81 that does not directly contribute to the reception sensitivity is arranged more downward than the mount 63 in FIG. 28. With this arrangement, the main substrate 81 does not block the radio waves from arriving at the sensor substrate 82. Since the main substrate 81 is arranged more downward in FIG. 28 than the lower edge of the inner tubular portion 72 of the translucent cover 7, the interference between the main substrate 81 and the translucent cover 7 is prevented, thus securing a larger space for disposing the main substrate 81.

The radar switching unit 8 is arranged at a position deeper than the opening 61 of the case 6 in the depth direction of the case 6. That is, the radar switching unit 8 is arranged at a position deeper in the depth direction of the case 6 than a portion of the translucent cover 7 exposed from the case 6. With such a structure, more light can be emitted outside through the translucent cover 7. In particular, a portion of light emitted from the LED unit 1 is reflected by the inner surface of the translucent cover 7. Since this reflected light is not blocked by the radar switching unit 8, it is advantageous in enhancing the luminance of the LED lighting apparatus A4.

The radar switching unit 8 includes the radar detector 80, and the switch 84 that is switched on and off based on a result of the detection by the radar detector 80. Also, the radar switching unit 8 is electrically interposed between the power unit 5 and the LED light-emitting unit 2. Accordingly, as long as the power unit 5 is ready to light the LED light-emitting unit 2 regardless of whether the user HM is present or not, the switch 84 of the radar switching unit 8 can solely determine whether to actually turn on the LED light-emitting unit 2 or not. This is advantageous in that, for example, the power unit 5 can be used as a common component between an LED lighting apparatus that does not include the radar detector 80 and the LED lighting apparatus A4.

Since the LED unit 1 includes the heat dissipater 3, dissipation of heat generated from the LED light-emitting unit 2 can be facilitated. The heat dissipater 3 as described above is made of a metal such as aluminum. The radar switching unit 8 is arranged in the exterior of the LED unit 1 having the aforementioned structure, and this arrangement is preferable in suppressing a decrease in the detection sensitivity of the radar switching unit 8.

The inner cover 4 has the light-incident flat surface 41, so that a larger quantity of the light from the LED light-emitting unit 2, which directly faces the light-incident flat surface 41, enters the light-incident flat surface 41. Since the light-emitting curved surface 42 bulges in the opening direction, the light received by the light-incident flat surface 41 are refracted and emitted to illuminate a larger area.

When relatively bright light travels forward in the main emission direction from the center of the LED light-emitting unit 2, the recessed surface 43 of the inner cover 4 reflects the light sideways. This makes it possible to prevent excessively bright light traveling forward in the main emission direction from the center of the LED light-emitting unit 2 from directly reaching an illumination area such as a room.

Since the light-incident flat surface 41 and the light-emitting curved surface 42 are rough, light can be diffused more efficiently when the light enters the light-incident flat surface 41 and exits at the light-emitting curved surface 42. Such a structure is suitable for wider illumination. In addition, since the recessed surface 43 is smooth, the light traveling forward from the center of the LED light-emitting unit 2 is efficiently reflected through total reflection.

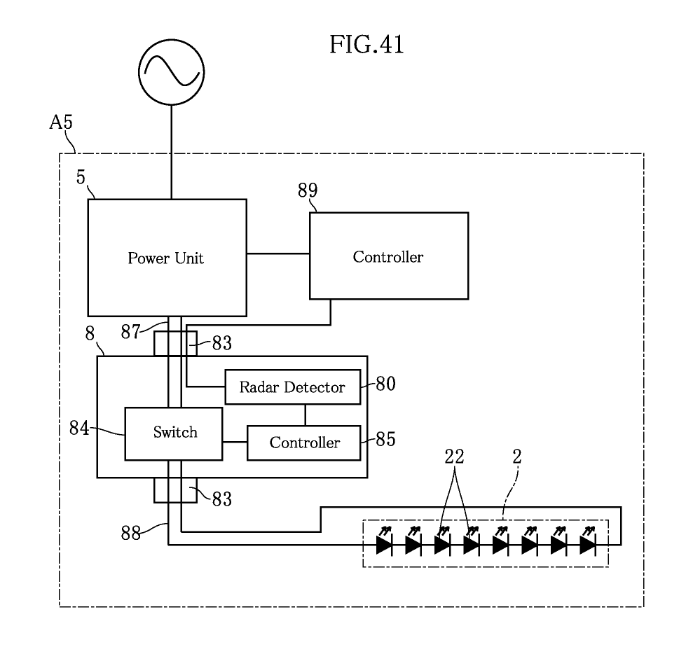

FIG. 41 shows a fifth embodiment of the present invention. Note that in this figure, elements that are the same as or similar to the elements in the above embodiment are provided with the same reference signs.

In an LED lighting apparatus A5 according to the present embodiment, a detection signal of the radar detector 80 of the radar switching unit 8 is transmitted not only to the controller 85 of the radar switching unit 8, but also to the controller 89 for the LED lighting apparatus A5 as a whole. The controller 89 controls the power supply from the power unit 5 according to state information. The state information is indicated by the detection signal from the radar detector 80, and includes data on whether an object such as a user HM is present or not. For example, suppose that the state information includes time and the brightness of the surroundings in addition to the data on whether an object is present or not. In this case, if it is daytime and the surroundings are bright enough, the controller 89 controls the LED light-emitting unit 2 so as not to light up even if the user HM is detected. Alternatively, if it is between the early evening and sunset and the surroundings are dark, the controller 89 controls the LED light-emitting unit 2 to light up with an appropriate luminance.

Such an embodiment can also save power without cumbersome operations.

The LED lighting apparatus according to the present invention should not be limited to the embodiments described above. Various design changes can be made to the specific configurations of the elements of LED lighting apparatuses according to the present invention.

Technical configurations of an LED illumination light provided by the present invention are enumerated below as appendixes.

### APPENDIX 1

An LED lighting apparatus including:

an LED light-emitting unit having at least one LED chip;

a radar detector configured to detect a movement of an object based on transmission of radio waves, reception of radio waves reflected by the object, and Doppler effect of the received radio waves that is a change in a wavelength of the received radio waves due to the movement of the object, where a light emission of the LED light-emitting unit is controlled based on a result of the detection of the radar detector;

a case that has a bottomed tubular shape and that has an opening; and

a translucent cover that covers the opening of the case and allows the light from the LED light-emitting unit and the radio waves from the radar detector to pass through, wherein

the radar detector is housed in the case at a position deeper than the LED light-emitting unit in a depth direction of the case.

### APPENDIX 2

The LED lighting apparatus according to Appendix 1, wherein the translucent cover allows the light from the LED light-emitting unit to diffuse when the light passes through the translucent cover.

### APPENDIX 3

The LED lighting apparatus according to Appendix 2, wherein the translucent cover is made of one of resin or glass.

### APPENDIX 4

The LED lighting apparatus according to any one of Appendixes 1 to 3, wherein the case is made of metal.

### APPENDIX 5

The LED lighting apparatus according to any one of Appendixes 1 to 4, wherein the translucent cover has an inner circumferential surface that stands erect from the opening of the case in the opening direction of the opening.

### APPENDIX 6

The LED lighting apparatus according to any one of Appendixes 1 to 5, further including a radar switching unit having the radar detection unit and a switch that is switched on and off based on a result of the detection by the radar detector.

### APPENDIX 7

The LED lighting apparatus according to Appendix 6, further including a power unit configured to supply electric power to the LED light-emitting unit.

### APPENDIX 8

The LED lighting apparatus according to Appendix 7, wherein the radar switching unit is electrically interposed between the power unit and the LED light-emitting unit.

### APPENDIX 9

The LED lighting apparatus according to any one of Appendixes 6 to 8, further including an LED unit having the LED light-emitting unit and the power unit.

### APPENDIX 10

The LED lighting apparatus according to Appendix 9, wherein the radar switching unit is arranged in an exterior of the LED unit.

### APPENDIX 11

The LED lighting apparatus according to Appendix 10, further including a first cable connecting the power unit and the radar switching unit.

### APPENDIX 12

The LED lighting apparatus according to Appendix 11, further including a second cable connecting the radar switching unit and the LED light-emitting unit.

### APPENDIX 13

The LED lighting apparatus according to any one of Appendixes 9 to 12, wherein the LED unit includes a heat dissipater to which the LED light-emitting unit is attached.

### APPENDIX 14

The LED lighting apparatus according to Appendix 13, wherein the heat dissipater has a top plate portion to which the LED light-emitting unit is attached, and a tubular portion that extends from the top plate portion in a direction opposite to a side to which the LED light-emitting unit is attached.

### APPENDIX 15

The LED lighting apparatus according to Appendix 14, wherein the tubular portion has an outer surface on which a plurality of fins are provided.

### APPENDIX 16

The LED lighting apparatus according to Appendix 15, wherein the power unit is housed in the tubular portion of the heat dissipater.

### APPENDIX 17

The LED lighting apparatus according to any one of Appendixes 13 to 16, wherein the LED unit has an inner cover that is attached to the heat dissipater and allows the light from the LED light-emitting unit to pass through.

### APPENDIX 18

The LED lighting apparatus according to Appendix 17, wherein the inner cover allows the light from the LED light-emitting unit to diffuse when the light passes through the inner cover.

### APPENDIX 19

The LED lighting apparatus according to Appendix 18, wherein the inner cover is made of one of resin or glass.

### APPENDIX 20

The LED lighting apparatus according to any one of Appendixes 17 to 19, wherein the inner cover has a light-incident flat surface that directly faces the LED light-emitting unit, and that receives the light from the LED light-emitting unit.

### APPENDIX 21

The LED lighting apparatus according to Appendix 20, wherein the inner cover has a light-emitting curved surface that is arranged opposite to the light-incident flat surface, and that bulges outward.

### APPENDIX 22

The LED lighting apparatus according to Appendix 21, wherein the inner cover has a recessed surface that is recessed from the light-emitting curved surface.

### APPENDIX 23

The LED lighting apparatus according to Appendix 22, wherein the recessed surface is cone-shaped.

### APPENDIX 24

The LED lighting apparatus according to Appendix 23, wherein the recessed surface overlaps the LED light-emitting unit in plan view.

### APPENDIX 25

The LED lighting apparatus according to Appendix 24, wherein a center of the recessed surface in plan view coincides with a center of the LED light-emitting unit in plan view.

### APPENDIX 26

The LED lighting apparatus according to any one of Appendixes 23 to 25, wherein the light-incident flat surface is rough.

### APPENDIX 27

The LED lighting apparatus according to Appendix 26, wherein the light-emitting curved surface is rough.

### APPENDIX 28

The LED lighting apparatus according to Appendix 27, wherein the recessed surface is smooth.

### APPENDIX 29

The LED lighting apparatus according to any one of Appendixes 1 to 28, wherein the at least one LED chip comprises a plurality of LED chips, and the LED light-emitting unit has the plurality of LED chips and an LED substrate on which the LED chips are mounted.

### APPENDIX 30

The LED lighting apparatus according to Appendix 29, wherein the LED light-emitting unit has a dam, and the dam is mounted on the LED substrate, has an annular shape that surrounds the plurality of LED chips, and protrudes from a surface of the LED substrate.

### APPENDIX 31

The LED lighting apparatus according to Appendix 30, wherein the dam is made of silicone resin.

### APPENDIX 32

The LED lighting apparatus according to Appendix 30 or 31, wherein the LED light-emitting unit has sealing resin that fills an area surrounded by the dam and covers the plurality of LED chips.

### APPENDIX 33

The LED lighting apparatus according to Appendix 32, wherein the sealing resin contains fluorescent substances that emit light at different wavelengths as a result of excitation by light from the plurality of LED chips.

1. An LED lighting apparatus comprising:
an LED light-emitting unit having a plurality of LED chips;
a radar detector configured to transmit radio waves, receive radio waves reflected by an object, and detect a movement of the object based on a change in a wavelength of the received radio waves;
a controller configured to control light emission of the LED light-emitting unit based on a result of the detection by the radar detector; and
a translucent cover that covers the LED light-emitting unit in a main emission direction in which a center of the light emitted from the LED light-emitting unit travels, the translucent cover allowing light from the LED light-emitting unit and the radio waves from the radar detector to pass through,
wherein the radar detector is surrounded by the LED light-emitting unit as viewed in the main emission direction.

2. The LED lighting apparatus according to claim 1, wherein the translucent cover allows the light from the LED light-emitting unit to diffuse as the light passes through the translucent cover.

3. The LED lighting apparatus according to claim 2, wherein the translucent cover is made of one of resin or glass.

4. The LED lighting apparatus according to claim 1, further comprising a radar switching unit that includes the radar detector and a switch that is switched based on a result of the detection by the radar detector.

5. The LED lighting apparatus according to claim 4, further comprising a power unit configured to supply electric power to the LED light-emitting unit.

6. The LED lighting apparatus according to claim 5, wherein the radar switching unit is electrically interposed between the power unit and the LED light-emitting unit.

7. The LED lighting apparatus according to claim 6, wherein the LED light-emitting unit has an LED substrate that supports the plurality of LED chips.

8. The LED lighting apparatus according to claim 7, wherein the LED substrate is annular as viewed in the main emission direction.

9. The LED lighting apparatus according to claim 7, wherein the LED light-emitting unit includes a plurality of LED modules each having the LED chips, the translucent resin that covers the LED chips and mount terminals.

10. The LED lighting apparatus according to claim 7, wherein the radar switching unit has a sensor substrate on which the radar detector is mounted, and a main substrate on which the switch is mounted.

11. The LED lighting apparatus according to claim 10, wherein the sensor substrate is arranged more forward than the main substrate in the main emission direction.

12. The LED lighting apparatus according to claim 11, wherein the main substrate and the sensor substrate overlap with each other as viewed in the main emission direction.

13. The LED lighting apparatus according to claim 12, wherein the sensor substrate is positioned more forward than the LED substrate in the main emission direction.

14. The LED lighting apparatus according to claim 13, wherein the sensor substrate is arranged in a position that avoids a light distribution angle that is a direction in which light of half a forward luminous intensity of each of the LED chips is emitted.

15. The LED lighting apparatus according to claim 13, wherein the main substrate is positioned more backward than the LED substrate in the main emission direction.

16. The LED lighting apparatus according to claim 12, wherein the sensor substrate and the LED substrate are integrated into a single substrate.

17. The LED lighting apparatus according to claim 7, further comprising:
a case that supports the LED light-emitting unit, the translucent cover, and the power unit; and
a base fixed to the case and attachable to a feeding unit.

18. The LED lighting apparatus according to claim 17, wherein the base is configured to be attached to or detached from the feeding unit by rotation of the base relative to the feeding unit.

19. The LED lighting apparatus according to claim 18, wherein the base includes a pair of pins that are spaced apart from each other in a radial direction that is perpendicular to the main emission direction.

20. The LED lighting apparatus according to claim 19, wherein the radar detector is sandwiched between the pair of pins in the main emission direction.

21. The LED lighting apparatus according to claim 20, wherein the radar switching unit is sandwiched between the pair of pins in the main emission direction.

22. The LED lighting apparatus according to claim 20, wherein the LED substrate overlaps with the pair of pins as viewed in the main emission direction.

23. The LED lighting apparatus according to claim 19, wherein the base includes a projection arranged between the pair of pins and protruding backward in the main emission direction.

24. The LED lighting apparatus according to claim 23, wherein the protrusion houses the power unit.

25. The LED lighting apparatus according to claim 24, wherein the power unit has a portion positioned more backward than the pair of pins in the main emission direction.

26. The LED lighting apparatus according to claim 6, further comprising a case for supporting the LED light-emitting unit, the translucent cover and the power unit, wherein the case has a bottomed tubular shape and is formed with an opening, and the translucent cover covers the opening.

27. The LED lighting apparatus according to claim 26, wherein the case is made of metal.

28. The LED lighting apparatus according to claim 26, further comprising an LED unit that includes the LED light-emitting unit, the power unit and the radar switching unit.

29. The LED lighting apparatus according to claim 28, wherein the LED unit includes a heat dissipater to which the LED light-emitting unit is attached.

30. The LED lighting apparatus according to claim 29, wherein the heat dissipater has a top plate portion and a tubular portion that extends from the top plate portion, and the LED light-emitting unit is attached to the top plate portion.

31. The LED lighting apparatus according to claim 30, wherein the tubular portion has an outer surface on which a plurality of fins are provided.

32. The LED lighting apparatus according to claim 31, wherein the power unit is housed in the tubular portion of the heat dissipater.

33. The LED lighting apparatus according to claim 29, wherein the LED unit has an inner cover, and the inner cover is attached to the heat dissipater and allows the light from the LED light-emitting unit to pass through.

34. The LED lighting apparatus according to claim 33, wherein the inner cover allows the light from the LED light-emitting unit to diffuse as the light passes through the inner cover.

35. The LED lighting apparatus according to claim 34, wherein the inner cover is made of one of resin or glass.
